(19) United States
(12) Patent Application Publication
(10) Pub. No.: US 2026/0244502 A1
(43) Pub. Date: Aug. 20, 2026

(54) EXECUTING A WORKFLOW USING A COMPOSED WORKER COMPUTER PROGRAM

(71) Applicant: Thread AI, Inc., New York, NY (US)

(72) Inventors: Mayada Gonimah, New York, NY (US); Angela McNeal, New York, NY (US); Martin McRoy, New York, NY (US); Jae Mahn Surh, Jersey City, NJ (US)

(21) Appl. No.: 19/092,463

(22) Filed: Mar. 27, 2025

Related U.S. Application Data
(60) Provisional application No. 63/760,771, filed on Feb. 20, 2025.

(51) Int. Cl. G06F 9/50

(52) U.S. Cl. CPC G06F 9/5027

(57) ABSTRACT

Executing a workflow using a composed worker computer program is disclosed, including: receiving an indication to execute a run of a worker program, wherein the worker program defines a workflow that comprises a graph that includes a set of processing states through which to process new data; receiving at least a portion of the new data at a first function of a first processing state; generating a set of intermediate output data from the first processing state based on the new data and the first function, wherein the graph defines that a second function in a second processing state is to receive the set of intermediate output data output by the first function; and transforming the set of intermediate output data from a first data modality to a second data modality that is compatible to be input into the second function.

### CROSS REFERENCE TO OTHER APPLICATIONS

This application claims priority to U.S. Provisional Patent Application No. 63/760,771 entitled EXECUTING A WORKFLOW USING A COMPOSED WORKER COMPUTER PROGRAM filed Feb. 20, 2025 which is incorporated herein by reference for all purposes.

### BACKGROUND OF THE INVENTION

As software services (e.g., open-source techniques and/or proprietary techniques) become more easily accessible, an organization may want to automate a workflow across several disparate services that are potentially also operated by different entities. However, different services may require input data of varying modalities and also require different application programming interfaces. As a result, it is challenging to automate a workflow of customized selections of services and that may also require selective data transformations between arbitrary services in the workflow.

### BRIEF DESCRIPTION OF THE DRAWINGS

Various embodiments of the invention are disclosed in the following detailed description and the accompanying drawings.

FIG. 1 is a diagram showing an embodiment of a system for composing and executing a worker program.

FIG. 2 is a diagram showing an example of a worker program composition and invocation server in accordance with some embodiments.

FIG. 3 is a flow diagram showing an example of a process for obtaining a composition of a worker program in accordance with some embodiments.

FIG. 4 is a flow diagram showing an example of a process for configuring a connector that has been added to a composition of a worker program in accordance with some embodiments.

FIG. 5 is a flow diagram showing an example of a process for configuring a processing state that has been added to a composition of a worker program in accordance with some embodiments.

FIG. 6 is a flow diagram showing an example of a process for configuring function(s) within a processing state that have been added to a composition of a worker program in accordance with some embodiments.

FIG. 7 is a flow diagram showing an embodiment of a process for executing a run of a worker program at runtime.

FIG. 8 is a flow diagram showing an example of a process for executing a run of a worker program at runtime in accordance with some embodiments.

FIG. 9 is a flow diagram showing an example of a process for calling a function with a current processing state during a run of a worker program at runtime in accordance with some embodiments.

FIG. 10A is a diagram showing an example of a user interface-based tool for composing a worker program at design time in accordance with some embodiments.

FIG. 10B is a diagram showing another example of a user interface-based tool for composing a worker program at design time in accordance with some embodiments.

FIGS. 11A and 11B show an example of a user interface for presenting a generated endpoint of a published worker program at design time in accordance with some embodiments.

FIG. 11C shows an example of a window that is presented in response to trigger a run of a published worker program at design time in accordance with some embodiments.

FIGS. 12A and 12B show the graph of an example of a published worker program configured to implement a workflow of a data extraction agent in accordance with some embodiments.

FIGS. 13A and 13B show the graph of an example of a published worker program configured to implement a workflow of an after action report generating agent in accordance with some embodiments.

FIG. 14 is a diagram that shows an example of a user interface for presenting run-specific audit data in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of executing a workflow using a composed worker computer program are described herein. An indication to execute a run of a worker program (which is sometimes referred to simply as “worker”) is received at runtime. The worker program was previously configured (during an earlier design time period prior to runtime) to define a workflow that comprises a graph that includes a set of processing states through which to process new data that is obtained by the worker program. In some embodiments, the worker program was previously configured/composed by a user via a configuration user interface or a software development kit (SDK). The worker program can represent an agent-style workflow of the new data that is obtained at the worker, including the logical flow of data from one processing state to another. The path of data through the processing states of the worker program associated with a particular run could vary with the runtime parameters of each particular run/instance of the worker program depending on characteristics of the new data and/or the time at which the worker program is invoked. For example, each one processing state may include zero or more functions, and where each function within a processing state may query a third-party or proprietary service. At runtime, the new data to the worker program is received at a first function of a first processing state. In some embodiments, new data is ingested by the worker program from either a data source defined in a connector of the worker program or a pass in with an invocation of the worker program (e.g., a call to the published endpoint of the worker program). After the new data is ingested by the worker program in the run, at least a portion of the new data is received at a first function of a first processing state in the worker program. A set of intermediate output data from the first processing state is generated based at least in part on the new data and the first function. Put another way, after the first function of the first processing state is applied to the new data, the resulting data is the set of intermediate output data that is to be fed to a second function in a second processing state as defined in the graph of the worker program. The set of intermediate output data is associated with a first data modality (e.g., data type). Examples of data modalities include tabular data, structured text, unstructured text, video data, imagery data, and audio data. In this run of the worker program, the set of intermediate output data is then transformed from the first modality to a second modality that is compatible to be input into the second function in the second processing state.

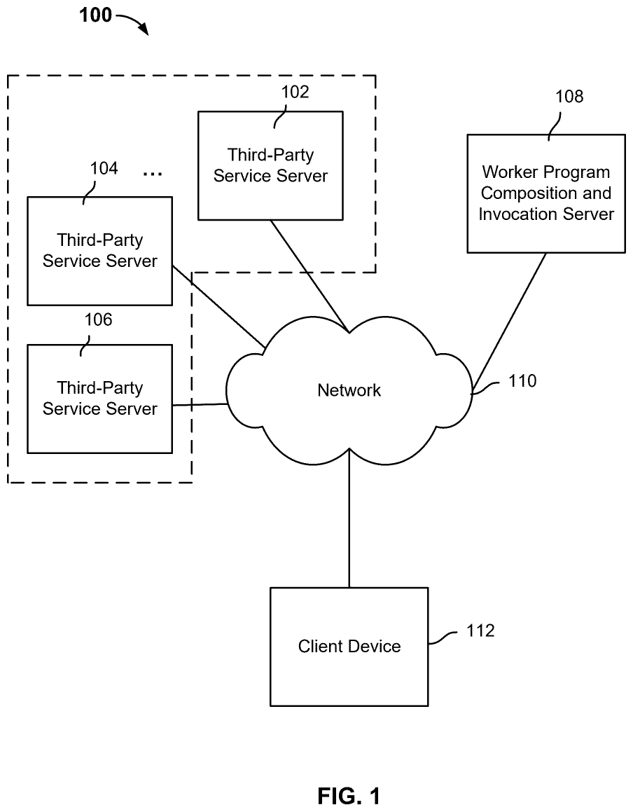

FIG. 1 is a diagram showing an embodiment of a system for composing and executing a worker program. As shown in FIG. 1, system 100 includes third-party service server 102, third-party service server 104, third-party service server 106, worker program composition and invocation server 108, network 110, and client device 112. Each of third-party service server 102, third-party service server 104, third-party service server 106, worker program composition and invocation server 108, and client device 112 can communicate to each other over network 110. Examples of client device 112 include a laptop computer, a desktop computer, a tablet device, or any computing device.

In some embodiments, worker program composition and invocation server 108 provides a worker composition user interface at a uniform resource locator (URL) that is accessible by a web browser executing at client device 112. At design time, client device 112 may be used by a user to access this worker composition user interface. At the worker composition user interface, a user using client device 112 can drag and drop or otherwise add representations of worker program elements (e.g., connectors, processing states, function(s) to be included in each processing state) into a worker composition input area and then add wiring to logically connect the elements to form a graph of worker elements. In a particular example sequence, a user can drag and drop connector(s) and processing states into the worker composition input area of the user interface. Next, the user can double click on each processing state to add one or more functions to that processing state. Then, the user can add connections/wiring among the connector/processing state elements to show the general logical flow through those elements. Furthermore, the user can use the worker composition user interface to configure parameters (e.g., via coding, selections from predetermined options, or a combination thereof) for each worker program element that is added to the worker composition input area of the user interface-based tool. In some embodiments, a “connector” element of a worker program comprises an element that is configured to check at a specified data source (e.g., a cloud-based storage location) for new data to be ingested by the worker. A worker program may be composed to include zero or more connectors. In some embodiments, a “processing state” element of a worker program is a logical container that directs the behavior of zero or more functions that have been configured to be included in that state. A worker program may be composed to include one or more processing states. There could be different types of processing states. A first example type of a processing state is “parallel” state, which is configured to execute multiple functions in parallel. A second example type of a processing state is a “call” state, which is configured to call a single function. A third example type of a processing state is a “for each” data field state, which is configured to call one or more functions for each data field that is input to the state. A fourth example type of a processing state is a human feedback (“handoff”) state, which is configured to send a notification to one or more specified users and pause the run of the worker until a response from the one or more users is received. A fifth example type of a processing state is a “trigger” state, which is configured to receive new data (e.g., sent to a published endpoint of the worker program) to trigger a new run/invocation of the worker. A sixth example type of a processing state is a “fallback” state, which is configured to be called at runtime when the function(s) of another processing state become unavailable. A seventh example type of a processing state is a “switch” state, which is configured to direct/map/route the run of the worker into a corresponding next processing state within the worker based on which preconfigured condition is met by the run. An eighth example type of a processing state is a “poll” state, which is configured to include one or more asynchronous functions. For example, a “poll” state type of processing state can be used to call a long running function (e.g., a transcription service). The “poll” state type of processing state can also be configured to poll the service associated with the function at a specified frequency such that if a condition is met (e.g., the requested translation is ready), the processing state will pull/obtain the results of the function (e.g., the completed transcription) back into the context of the current run of the worker. A ninth example type of a processing state is a “set” state, which is configured to enable modification of the information, constants, and variables stored in the context of a run during the duration of the run (e.g., update a counter, modify a language model prompt, set or unset a flag). A tenth example of a processing state is a “worker” state, which is configured to call/execute/invoke a run of another worker. Put another way, a “worker” state within a current run of a first worker can be triggered to invoke an independent run of a second worker. The “worker” state that is included in the graph of the first worker can be configured to receive the results output from the called run of the second worker or not. An eleventh example of a processing state is a “router” state, which is configured to select a subset of existing worker types of processing states (as described above) to trigger based on given inputs/constraints using instructions provided to a “route engine” language model (e.g., a language model used to make routing decisions for given inputs). The “router” state can be configured with instructions on which routes can be selected and which data from the run-specific context should be used to make selections for each routing decision. For example, each route that is selectable by the “router” state is configured with a name, a single worker, a brief description of the route, and the input data that should be passed when that route is selected. When a “route” state is run, each route is run in parallel and the “router” state is only considered completed once all the selected routes have completed. In some embodiments, a “function” element of a worker program is composed to be included in a processing state and is configured to call an endpoint of a third-party service (e.g., that is provided by one of third-party service server 102, third-party service server 104, third-party service server 106) or some other proprietary service (e.g., that is executing in a compute service executing at a host server) via a service-specific calling framework, application programming interface (API), and/or protocol (e.g., REST, GRPC, and GraphQL). Examples of third-party services (e.g., provided by one or more of third-party service server 102, third-party service server 104, third-party service server 106) that can be called by a function include a transcription service, a translation service, a summarization service (e.g., that uses generative artificial intelligence (AI) such as a large language model (LLM)), and a storage service. As will be described in further detail below, a set of parameters is to be configured for each function that is composed to be included in a particular processing state. Examples of the parameters that can be configured for a pair of function and processing states include the source of the data that is to be input into the function, the modality of the data that is to be input into the function, a set of credentials to be used to authenticate a call to a third-party service, a web address (e.g. URL) to use to ping the third-party service, retry conditions, a destination of the data that is to be output from the function, and the modality of the data that is to be output from the function. In some embodiments, “data modality” refers to a set of attributes associated with data. Examples of one or more attributes that describe the modality of data include, but are not limited to: a data format, a data type, a data structure, and a data protocol/framework.

In various embodiments, “data transformation” refers to the transformation of data from one modality to another modality at runtime. Each of one or more functions in a processing state of the worker program can perform, at runtime, data transformation on the data that is input into that function, depending on the nature of the function. Another type of data transformation that can occur at runtime is transformation of data as it is passed (“in transit” or “inline”) from a connector to a function in a processing state, or transformation of data as it is passed from a function in one processing state to another function in another processing state. In some embodiments, such “in transit” or “inline” data transformation between adjacent pairs of nodes (e.g., connector-to-function, function-to-function) can be user configured at design time using expression language that is exposed at the user interface-based worker composition tool. In some embodiments, such “in transit” or “inline” data transformation between adjacent pairs of functions and processing states can be also programmatically inferred using artificial intelligence (e.g., based on the configured parameters of the adjacent functions) and added to the worker program by worker program composition and invocation server 108 at design time or during a run of the worker program at runtime. Specific examples of inline data transformations between adjacent nodes in a graph include transforming data across protocols (e.g., REST, GraphQL, gRPC) and/or data movement (e.g., streaming, batch). One concrete example of transforming data across modalities is when emergency incident data is passed as an audio stream (e.g., from an upstream node), which is then chunked and passed to a downstream processing state that comprises a batch categorization model (e.g., to identify a fire incident within the input data). Implementation-wise, this would involve a streaming transcription model which uses gRPC as a protocol but the categorization model was batch and REST based.

As will be described in further detail below, the configured parameters for each function and processing state within the worker program will determine the possible flow of data during each invocation/run of the worker program at runtime.

In some embodiments, in addition or alternative to providing the user interface-based worker composition tool, worker program composition and invocation server 108 is configured to provide a software development kit (SDK) to developers to build worker programs. The SDK includes at least a code library that enables a developer (e.g., using client device 112) to compose a worker program using the elements described above using a computer coding-based interface.

After a user/developer indicates the completion of the composition of a worker program via either the user interface-based tool or the SDK, worker program composition and invocation server 108 is configured to validate the composition of the elements and connections/writing of the elements of the worker. Upon validation, worker program composition and invocation server 108 is configured to store the composition in a domain-specific language (DSL) format and publish an endpoint (e.g., an URL) of the entire worker program. For example, a user can expose the worker program to be invoked/called by integrating the worker's endpoint in an application or at a website.

At runtime, a run of a published worker program that was previously composed/configured at design time and stored at worker program composition and invocation server 108 can be invoked and executed at worker program composition and invocation server 108. In some embodiments, a run of the worker program can be invoked with a call (e.g., a curl command, or a user selection of a button on a website or application) to the worker (e.g., if the worker has a trigger processing state). In some embodiments, a run of the worker program can be invoked based on a connector of the worker program detecting new data at the specified data source. For example, a connector of the worker program can be configured to periodically check a specified data source for new data (e.g., if the worker has a connector) or the connector can be manually triggered to check for data at the specified data source. In some embodiments, a run of the worker program can be invoked based on a manual input of data to the worker program. Regardless of the manner of invoking a run of the worker program, new data is passed into the worker program for a particular run. The new data that is passed into the worker program at runtime in a particular run of the worker program will be processed by the function(s) of a first processing state. The data output from the function(s) of the processing state can be referred to as “intermediate output data” if it will continue to be additionally processed by the function(s) of the (logically) next processing state that is defined in the graph of the worker program. The intermediate output data from this second function will be input into the function(s) configured for the (logically) next processing state that is defined in the graph. As such, in this particular run of the worker program, the new data that enters/is ingested by the worker program may be processed by a series of processing states (and the functions thereof) in correspondence with the workflow that is defined by the worker program until the (logically) last processing state is reached. For example, the function(s) of the last processing state can output (e.g., present or write) the final output data to a specified destination (e.g., cloud storage location, destination user interface, destination device, a destination database, or trigger a subsequent program).

Worker program composition and invocation server 108 can execute the particular run of the worker program to go through a logical path of the connector(s) and/or processing states in the worker that corresponds to the directions of the connections/wiring that have been composed among the elements. However, the flow of data through the worker program may not necessarily correspond to the seemingly linear logical flow among the connector/processing state elements as indicated by the connections/writing among them. Put another way, a function of one processing state may not necessarily receive data from a function in another processing state in the worker program that immediately precedes it, logically as defined in the graph. This is because the data flow may return recursively to a logically prior processing state and/or loop back to a previously visited processing data, depending on certain factors. Examples of such factors include the nature of the source/new data that enters/is ingested by the worker program, the input schema that is configured for a connector in the worker program, the availability of services that are to be called by the functions of visited processing states, and a received response at a human feedback processing state.

The data flow through the run of the worker program can be referred to as the “context” of the run and it is stored by worker program composition and invocation server 108 in a run-specific data plane, which is a backend infrastructure abstraction. As mentioned, in a run of the worker program, the data that enters/is ingested by the worker can be transformed from one modality to another modality at various functions of processing states and/or in transit between two nodes (e.g., where a node can be a connector or a function within a processing state) of the worker. The input data that is input into and also the intermediate output data that is output by a particular node of the worker can be persisted within the run-specific data plane in the most appropriate format for each modality. For example, intermediate output data that is CSVs or rows can be stored in one format and video data can be stored in a different format within this context/data plane. Put another way, during a particular run of the worker program, input data into and intermediate output data from nodes can be written to and read from the run-specific context/data plane, which enables complicated and flexible data transformations, retries of a function, recomputes of at least a portion of the run, and also an audit log of the data through the workflow in this run. In addition to documenting the data flow in an audit log for a run, worker program composition and invocation server 108 can also document the logical data path of the run in another audit log for the same run. In some embodiments, worker program composition and invocation server 108 can execute multiple invoked runs of the same worker program in parallel and persist the audit logs specific to each run.

As described above, in various embodiments, system 100 enables the composition of worker programs that define complicated agent-style workflows of handling data through disparate services. The flexible composition of a worker program can enable a user to leverage existing service provider(s) in one or more locations within an otherwise custom-defined series of arbitrary processing states for each particular use case/application. A worker program can also be defined to request a user to review data in the beginning, middle, or end of the workflow to ensure that human guardrails and subject matter expertise are leveraged where appropriate. Furthermore, during the run of a worker program at runtime, worker program composition and invocation server 108 can store and transform data among various data modalities (e.g., tabular data, video data, audio data, text data) to ensure that the appropriate modality of data is always input into the next processing state of the workflow. Additionally, audit logs that track the logical path and context/data plane are persisted for each run of a worker program to enable easy recompute, troubleshooting, and analysis of historical worker invocations. All in all, a worker program that is configured to include an arbitrary series of processing states/functions and that is executed by worker program composition and invocation server 108 offers a more flexible and customizable extract, transform, and load (ETL) process that is possible through traditional ETL techniques.

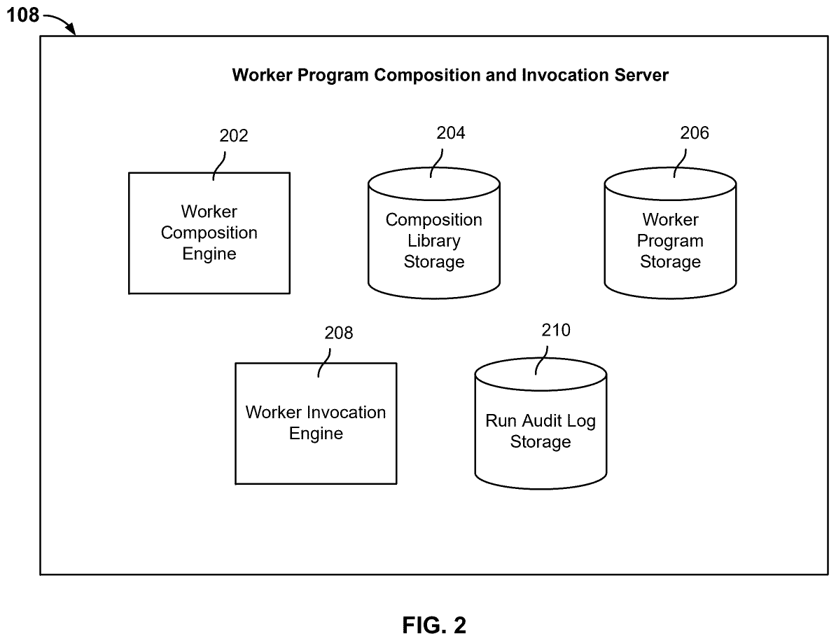

FIG. 2 is a diagram showing an example of a worker program composition and invocation server in accordance with some embodiments. In some embodiments, worker program composition and invocation server 108 of FIG. 1 may be implemented, at least in part, using the example of FIG. 2. In the example of FIG. 2, the worker program composition and invocation server includes worker composition engine 202, composition library storage 204, worker program storage 206, worker invocation engine 208, and run audit log storage 210. Each of worker composition engine 202, composition library storage 204, worker program storage 206, worker invocation engine 208, and run audit log storage 210 may be implemented using software and/or hardware (e.g., one or more processors and/or one or more memories).

Worker composition engine 202 is configured to provide a tool to enable a developer user to compose a worker program at design time. As described above, a worker program describes a graph of processing states with included functions, and this graph can map to a blueprint for a business process or workflow. In some embodiments, worker composition engine 202 is configured to provide a user interface-based tool for composing a worker program. As described above, at such a user interface, a user can add visual representations of processing states (of one or more types) and, optionally, connector(s) into a worker composition input area. Then, the developer can select (e.g., via double clicking) each processing state and each connector, if any, to configure that element. A processing state can be configured by the user adding one or more functions and/or other conditions within the state. For each function that is added to each processing state, the user can configure parameters including at least the source of the input data into that function (e.g., which could be another function located within the same or a different processing state) and modality of that input data. A connector can be configured by a user to specify at least a data source, an input schema of new data to be obtained from the specified data source, and one or more triggers to check the data source for new data. After configuring the processing states and connector(s), if any, in the worker composition input area of the worker program, the user can add directional connections among the processing states and any connector(s) in the worker composition input area to define the logical flow among the elements, which will form a graph. In some embodiments, worker composition engine 202 is configured to provide a SDK to enable developers to compose a worker program in a coding environment at design time. In some embodiments, worker composition engine 202 is configured to additionally receive (e.g., via the user interface-based tool or the SDK) any developer configured in transit/inline data transformations (e.g., which are described in expression language) between adjacent nodes (nodes that are upstream and downstream of each other in terms of data flow) of the graph. In some embodiments, worker composition engine 202 is configured to programmatically infer and configure the data transformations that are needed within adjacent nodes of the graph. As described above, in transit data transformations of data from one modality to a different modality help ensure that the compatible portion and modality of the data of the intermediate output data output from the upstream node (e.g., connector or function within a processing state) is fed/input into the immediate downstream node (e.g., function with a next processing state) of the graph during a run of the worker program.

In some embodiments, during the composition of a worker program, the user interface-based tool or the SDK may include preconfigured template worker elements, including preconfigured connectors, processing states, and functions that are stored at composition library storage 204. In some embodiments, composition library storage 204 may also store preconfigured graphs or subgraphs (of connected connectors and/or processing states) that define a workflow or portion thereof. During the composition of the worker program, a developer can select among one or more preconfigured worker elements or preconfigured graphs/subgraphs to add/import into the worker program that is currently being defined. For example, composition library storage 204 can store preconfigured worker elements and graphs/subgraphs that are commonly used or have been empirically determined to provide high-quality data processing, and as such, developer users can leverage such components/building blocks to more quickly and effectively compose a new, longer graph/workflow.

After a developer user indicates that the composition of a worker program has completed and that the worker program is ready to be published, in some embodiments, worker composition engine 202 is configured to validate the completed graph of the worker program. For example, validation of the completed graph includes checking whether all the elements of the worker program have been connected to at least one other element via a connection/wire and whether all needed parameters/variables of a processing state/function have been set. After the worker program has been successfully validated, worker composition engine 202 is configured to convert the worker program that has been composed in either the user interface-based tool or the SDK into a DSL format and then stores the DSL associated with the newly defined worker at worker program storage 206, which stores the DSL or other files of composed and validated worker programs. Worker composition engine 202 is configured to also dynamically generate an endpoint (e.g., a URL) that can be used to expose the worker program to an operational context (e.g., an application request or user request) that wants to call/invoke a run/instance of executing the worker program with new data. A completed worker program for which an endpoint has been generated can also be manually triggered to perform one or more test runs prior to integrating the worker program-level endpoint into an operational context.

Worker invocation engine 208 is configured to receive an invocation of a run of a worker program (e.g., for which the DSL or other file(s) are stored at worker program storage 206). In a first example, if the worker program has at least one connector, then a run of the worker can be invoked by the connector detecting new data at the specified data source and/or the connector being manually synced to provided new data. In a second example, the worker program could have been called by its corresponding worker-level endpoint and where the call (e.g., a curl command that sends the new data to the HTTP endpoint) includes new data to be passed into the worker. In a third example, the worker group could have been called if new data is manually passed into a specified processing state of the worker program. If the new data enters/is ingested by the worker program from a connector, then worker invocation engine 208 is configured to compare the new data to an input schema configured for the connector and use the input schema to map data fields of the new data to appropriate processing states and functions thereof within the graph. If the new data enters/is ingested by the worker program through a call to the worker's endpoint, then worker invocation engine 208 is configured to process the new data at the first processing state and function thereof within the graph. Thereafter, the data that is received at a function of a particular processing state is processed according to the local computation/processing or third-party service to be called by that function to generate intermediate output data. Worker invocation engine 208 is configured to determine which function of which processing state to pass the intermediate output data for additional processing, for example, based on the next logical processing state that appears in the graph and/or the parameters (e.g., related to the input source) of another function in the graph. Depending on the next function of a next processing state to which the intermediate output data is to be routed, data transformation may be performed on the intermediate output data to change the modality of the data from a first modality that is not compatible with the input parameters of that next function to a second modality that is compatible with the input parameters of that next function. In this way, during a particular run, worker invocation engine 208 is configured to pass the intermediate output data from one processing state/function to the next processing state/function through the graph of the worker program and perform in transit/inline data transformations (e.g., as inferred at runtime and/or documented in the worker program itself) between adjacent functions as needed. If worker invocation engine 208 reaches a special processing state in the graph that is associated with requiring human feedback (e.g., a “handoff” state or a “human in the loop” state) during the run, worker invocation engine 208 is configured to send a notification to each user (e.g., over one or more specified request communication channels) to request a type of user response as described in the parameters of that particular processing state. When a special, human feedback processing state is reached, worker invocation engine 208 is configured to pause the run until the unblock conditions configured for that processing state are met. For example, unblock conditions may describe a timeout period or the receipt of a particular user response and also, a next processing state in the graph corresponding to each met condition. For example, a human feedback processing state may send the intermediate output data that is received from the immediately previous processing state to a user to solicit a feedback (e.g., an approval or a rejection) on that intermediate output data and then route the run of the worker to an appropriate next processing state depending on the type of user feedback that is received. Worker invocation engine 208 is configured to run the worker program until the final processing state is reached or an exception occurs. As mentioned above, the final processing state may include a function that outputs the final data by, for example, presenting the final output data at a user interface, sending the final output data to a destination device, storing the final output data at a destination (e.g., cloud) storage location, or writing the final output data to a file of a productivity application (e.g., a spreadsheet or document application).

As worker invocation engine 208 executes a run of a worker program, worker invocation engine 208 is also configured to concurrently generate and store audit logs corresponding to the run at run audit log storage 210. In some embodiments, for each run of a worker program, worker invocation engine 208 is configured to store an audit log of the logical path that the run took through the graph (e.g., from which connector or processing state the new data entered/is ingested by the graph, which processing states were visited and in which order, etc.). In some embodiments, for each run of a worker program, worker invocation engine 208 is configured to also store an audit log of the context/data plane associated with the run. For example, the context/data plane associated with a run of a worker program persists that the data is input and output of each processing state as the run proceeds on a path through the graph, as well as any runtime parameters associated with the run. In some embodiments, the same or different retention policies can be configured to both run-specific path audit logs and context/data plane audit logs. One advantage of maintaining such audit logs is to create records of each different run of a worker program. The same worker program can be invoked with different new data and/or at different times, which could influence the path that each respective run takes through the graph and could also result in a different corresponding context/data plane. Creating and persisting the audit logs could enable users to observe or even troubleshoot the workflow defined by the worker program and to potentially prompt the composition of a new workflow/worker program or even the re-computation of a previously executed run of the worker program.

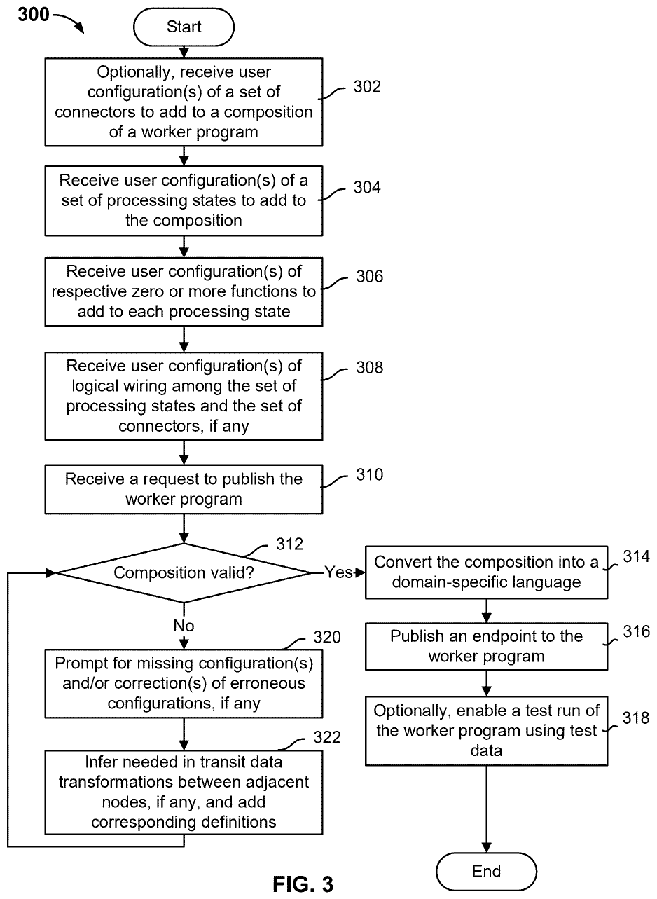

FIG. 3 is a flow diagram showing an example of a process for obtaining a composition of a worker program in accordance with some embodiments. In some embodiments, process 300 may be implemented, at least in part, at worker program composition and invocation server 108 of FIG. 1.

Process 300 describes an example process of receiving configurations for composing a worker program from a developer user over either the user interface-based tool or the SDK at design time.

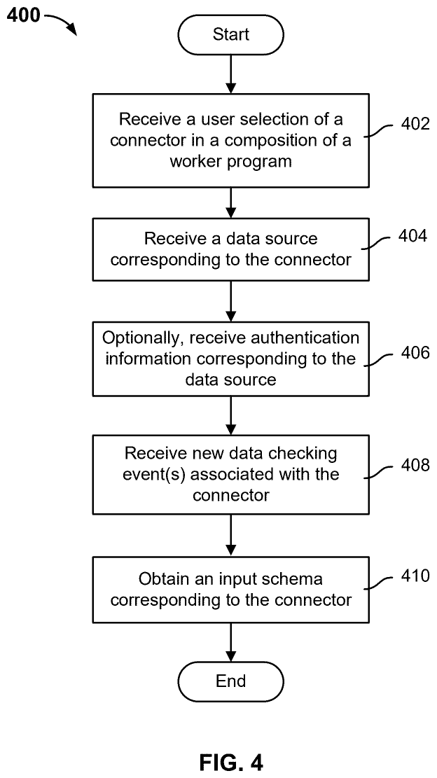

At 302, optionally, user configuration(s) of a set of connectors to add to a composition of a worker program are received. As mentioned above, a connector element is a mechanism to pull new source data from a specified data source. In some embodiments, at runtime, new data being pulled by the connector from the specified data source will invoke a run of the worker program (e.g., an execution of an instance of the worker program). In some embodiments, at runtime, an invocation of a run of the worker program can cause new data to be pulled by the connector from the specified data source. Examples of a data source are a cloud storage bucket or a database. FIG. 4, below, describes an example process of configuring how, when, and where a connector will check for new data that can be configured.

However, the composition of a worker program does not need to include any connectors because, at runtime, new data can also be pulled into the worker in other ways to invoke a run of the worker program.

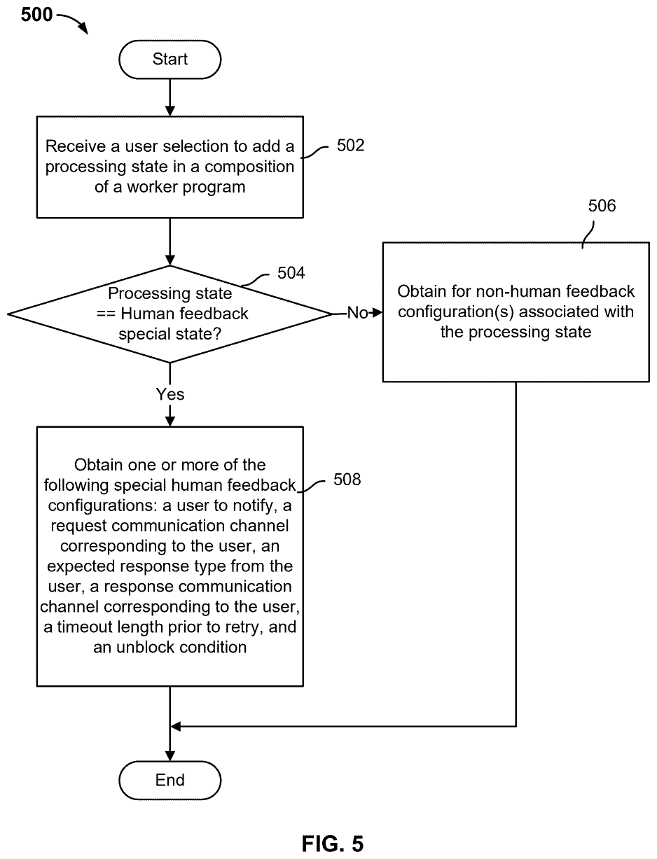

At 304, user configuration(s) of a set of processing states to add to the composition are received. In various embodiments, each processing state in a worker program represents a logical container that either selects a next processing state to handle the input data or processes the input data using one or more enclosed functions, as will be described below. As mentioned above, there could be multiple types of processing states. A first example type of a processing state is a “parallel” state, which is configured to execute multiple functions in parallel. A second example type of a processing state is a “call” state, which is configured to call a single function. A third example type of a processing state is a “for each” data field state, which is configured to call one or more functions for each data field that is input to the state. A fourth example type of a processing state is a human feedback (“handoff”) state, which is configured to send a notification to one or more specified users and pauses the run of the worker until a response from the one or more users is received. A fifth example type of a processing state is a trigger state, which is configured to receive new data (e.g., sent to a published endpoint of the worker program) to trigger a new run/invocation of the worker. A sixth example type of a processing state is a “fallback” state, which is configured to be called at runtime when the function(s) of another processing state become unavailable. A seventh example type of a processing state is a “switch” state, which is configured to direct/map/route the run of the worker into a corresponding next processing state within the worker based on which preconfigured condition is met by the run. An eighth example type of a processing state is a “poll” state, which is configured to include one or more asynchronous functions. For example, a “poll” state type of processing state can be used to call a long running function (e.g., a transcription service). The “poll” state type of processing state can also be configured to poll the service associated with the function at a specified frequency such that if a condition is met (e.g., the requested translation is ready), the processing state will pull/obtain the results of the function (e.g., the completed transcription) back into the context of the current run of the worker. A ninth example type of a processing state is a “set” state, which is configured to enable modification of the information, constants, and variables stored in the context of a run during the duration of the run (e.g., update a counter, modify a language model prompt, set or unset a flag). A tenth example of a processing state is a “worker” state, which is configured to call/execute/invoke a run of another worker. Put another way, a “worker” state within a current run of a first worker can be triggered to invoke an independent run of a second worker. The “worker” state that is included in the graph of the first worker can be configured to receive the results output from the called run of the second worker or not. An eleventh example of a processing state is a “router” state, which is configured to select a subset of existing worker types of processing states (as described above) to trigger based on given inputs/constraints using instructions provided to a “route engine” language model (e.g., a language model used to make routing decisions for given inputs). The “router” state can be configured with instructions on which routes can be selected and which data from the run-specific context should be used to make selections for each routing decision. For example, each route that is selectable by the “router” state is configured with a name, a single worker, a brief description of the route, and the input data that should be passed when that route is selected. When a “route” state is run, each route is run in parallel and the “router” state is only considered completed once all the selected routes have completed. The composition can be configured to include one or more types of processing states and also zero or more instances of each type of processing state. FIG. 5, below, describes an example process of configuring a processing state.

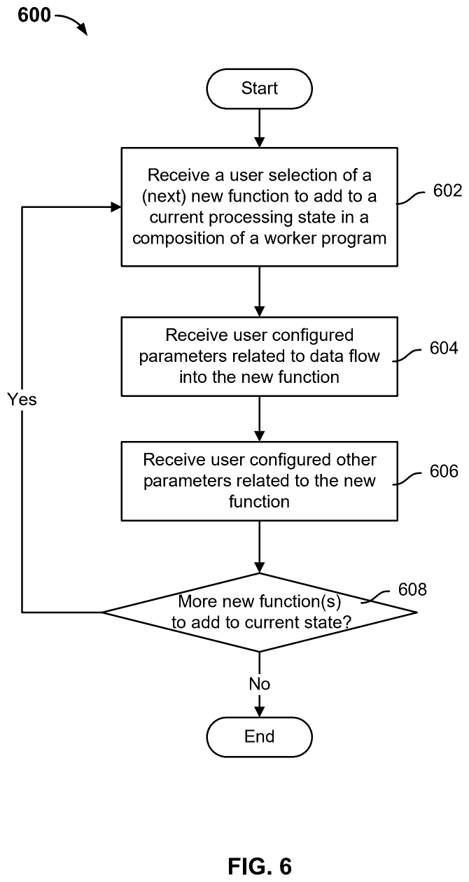

At 306, user configuration(s) of respective zero or more functions to add to each processing state are received. In some embodiments, after the processing states are configured, depending on the type of each processing state, zero or more functions can be added to and configured for that state. For example, a “switch” state type of processing state will not require a function because its required configurations are switching conditions that route data that is input into the switch state into a corresponding destination, next processing state of the same worker program. For example, a “call” state type of processing state should include one function that will be called when a run reaches that particular state. For example, a “parallel” state type of processing state should include two or more functions that will each be called when a run reaches that particular state. Each function that is added to a processing state can call a proprietary model/function or call a third-party service (e.g., such as an AI-based model). FIG. 6, below, describes an example process of configuring function(s) for a processing state.

At 308, user configuration(s) of logical wiring among the set of processing states and the connectors, if any, are received. The logical wiring/connections among the zero or more connectors and the set of processing states indicate the logical sequence/directions in which data is processed across the processing states. The processing states may not necessarily be wired up in a linear manner because, for example, two or more of the processing states may be operating in parallel, one processing state may be configured to be called as a fallback when another processing state or function thereof is unavailable, or two or more of the processing states are configured to be alternatives of each other and any one of them could be called depending on a corresponding criterion. After the connector(s) and/or processing state elements of the composition are connected by wires, the result is a graph of such connected elements.

While not shown in FIG. 3, in some embodiments, configurations for in transit/inline data transformations between pairs of adjacent nodes in the graph of the worker program are also received for the composition. As mentioned above, an in transit data transformation describes how intermediate output data that is output from the upstream processing state or connector should be transformed from its original modality to another modality that is compatible with/accepted by/required by the downstream processing state of its input data.

At 310, a request to publish the worker program is received. When the developer user has completed the composition of the worker program, the developer user can submit a command or select a button associated with publishing the worker program.

At 312, whether the composition is valid is determined. In the event that the composition is valid, control is transferred to 314. Otherwise, in the event that the composition is not valid, control is transferred to 320. In response to an indication to publish the worker program, one or more validation checks can be performed on the composition. A first validation check confirms if all the configured elements have been wired to at least one other element in the graph. A second validation check confirms whether the resulting graph is a valid graph. A third validation check confirms whether all the required configurations/variables/parameters within each connector, processing state, and/or function have been set. A fourth validation check confirms whether any needed required in transit/inline data transformations in the graph have been configured.

At 314, the composition is converted into a domain-specific language (DSL). The valid composition (either as a visual representation or a computer code-based representation) is converted into a (e.g., proprietary) DSL representation of the worker program.

At 316, an endpoint to the worker program is published. An endpoint for the worker program is then dynamically generated. In various embodiments, the worker-level endpoint is an HTTP endpoint. The endpoint of the worker program can be incorporated into any desirable operational context. For example, the worker-level endpoint can be exposed to a user or a software process at a website or an application. As will be described in further detail below, a worker program that is behind an endpoint can be invoked to run any number of times and different runs of the same worker program (with potentially different ingested data) can even be executed concurrently and respective run-specific audit logs could be recorded.

At 318, optionally, a test run of the worker program is enabled using test data. For example, the now published worker program can optionally be manually triggered by the developer user with test data to generate one or more test runs. The advantage for a developer user for being able to invoke a test run with known test data is to confirm/observe that the recorded audit logs of the run are consistent with the desired workflow that the worker program has been configured to programmatically implement.

At 320, missing configuration(s) and/or correction(s) of erroneous configurations, if any, are prompted for. In the event that the composition has failed any of the validation checks related to missing/erroneous connector, processing state, worker, or wiring configurations, the developer user is prompted to edit the composition to supply the erroneous or missing configurations/variables/parameters/wirings and then the updated composition is validated again at 312.

At 322, needed in transit data transformations, if any, between adjacent nodes are inferred and definitions of the in transit data transformations are added. In the event that the composition has failed a validation check related to missing in transit/inline data transformations, in some embodiments, the required data transformation (if any) between each pair of adjacent nodes in the graph is programmatically inferred, defined, and the definitions are added to the composition. For example, the in transit data transformation between a given pair of nodes in the graph can be inferred based on the expected data modality of the intermediate data that is to be output from the upstream node and the required data modality of the data that is to be input into the downstream node (e.g., as indicated by the input data parameters configured for the downstream node). Adding the definitions of the inferred in transit data transformations between adjacent nodes in the graph will ensure the smooth (e.g., error-free) passing of data from one node to the next during each run of the worker program at runtime.

In some embodiments, after the endpoint of the worker program is published, the stored worker program can be opened for additional editing. For example, a new version of the worker program (e.g., to implement a partially different workflow) can be created by editing the graph of the worker program and/or one or more functions of the graph can be replaced with different functions (e.g., endpoints of different service providers).

FIG. 4 is a flow diagram showing an example of a process for configuring a connector that has been added to a composition of a worker program in accordance with some embodiments. In some embodiments, process 400 may be implemented, at least in part, at worker program composition and invocation server 108 of FIG. 1. In some embodiments, step 302 of process 300 of FIG. 3 may be implemented, at least in part, using process 400.

Process 400 describes an example process for configuring a connector that has been added to a composition of a worker program at design time. An instance of process 400 can be implemented for each connector that is added to the composition of the worker program.

At 402, a user selection of a connector in a composition of a worker program is received.

At 404, a data source corresponding to the connector is received. A location or other identifying information associated with the data source from which the connector should pull new data into the worker during runtime is received. For example, the data source is the address (e.g., URL) of a cloud storage bucket.

At 406, optionally, authentication information corresponding to the data source is received. In some embodiments, authentication information (e.g., credentials or some other authorization information) that is needed to access data that has been stored to the data source is configured to the connector.

At 408, new data checking event(s) associated with the connector are received. Which event(s) should trigger the connector to check for new data at the data source specified in step 404 can be configured. In a first example, a new data checking event can be a specified time interval (e.g., every 20 minutes). In a second example, a new data checking event can be a received trigger/call to invoke a run of the worker program at a processing state of the worker. In a third example, a new data checking event can be to constantly listen for the presence of new data at the specified data source.

At 410, an input schema corresponding to the connector is obtained. The definition of the input schema is received. The input schema describes which data fields are required to be pulled from the data source and also to which next processing state which portion of the new data should be mapped. For example, at runtime, the input schema can filter the data fields from the new data that are actually needed by the processing state(s) (or function(s) thereof) and write those needed data fields to the context/data plane of the current run of the worker program so the downstream nodes can read that data as input. Put another way, the input schema of a connector funnels and filters the portions of the ingested new data from the data source to make such data available in the context to downstream nodes within the graph of the worker program. If at runtime, the new data that is ingested by the connector does not include at least one data field that is required in the input schema, then the run will result in an error. In some embodiments, if the input schema for a connector is not user defined, then the input schema may be inferred and programmatically defined based on the input parameters that have been user configured to the processing state(s) that have been configured to be logically downstream of the connector.

In some embodiments, during runtime, the connector should check the specified data source at each new data checking event for new data. If the connector detects new data at the data source, the connector should pull/ingest that new data into a run of the worker and compare the ingested data against the defined input schema. The connector will then write the at least portion of the ingested data that may be needed (as input) by one or more processing states within the graph of the worker program in a run-specific context/data plane.

FIG. 5 is a flow diagram showing an example of a process for configuring a processing state that has been added to a composition of a worker program in accordance with some embodiments. In some embodiments, process 500 may be implemented, at least in part, at worker program composition and invocation server 108 of FIG. 1. In some embodiments, step 304 of process 300 of FIG. 3 may be implemented, at least in part, using process 500.

Process 500 describes an example process for configuring a processing state that has been added to a composition of a worker program at design time. In particular, process 500 checks for whether the processing state is a special type that requires human feedback (is a “handoff” state) and if so, prompts for configurations that are specific to that special state. An instance of process 500 can be implemented for each processing state that is added to the composition of the worker program.

At 502, a user selection to add a processing state in a composition of a worker program is received.

At 504, whether the processing state is a human feedback special state is determined. In the event that the processing state is not a human feedback special state, control is transferred to 506. Otherwise, in the event that the processing state is a human feedback special state, control is transferred to 508. As mentioned above, there could be various types of processing states. The type of a processing state is selected by the developer user when the state is added to the composition. If the type of the current processing state were selected to be one that requires human feedback (the “handoff” state), then special configurations related to this special state could be prompted of the developer user that is creating the composition.

At 506, non-human feedback configurations associated with the processing state are obtained. However, if the type of the current processing state were selected to be one that does not require human feedback, then configurations that are not related to the special state of human feedback is prompted of the developer user that is creating the composition. If the type of the current processing state were selected to be one that includes functions (e.g., the “parallel” state, the “call” state, the “for each” data field state, the “fallback” state, etc.), then prompts for metadata (e.g., the name) of the state and the function(s) to be added to the state are provided for the developer user, which is described in further detail in the example of FIG. 6, below. But if the type of the current processing state were selected to be one that does not require any functions (e.g., the “switch” state), then prompts for the parameters/metadata (e.g., the name) of the function-less state are prompted. In particular, if the current processing state were a “switch” state, then prompts for two or more conditions and the respective next/destination processing state in the graph for each condition are provided. For example, each condition of a switch state is a “if, then” condition where, at runtime, if the input data to that state matches a certain condition, then the run would be routed to the next/destination processing state that corresponds to that met condition.

At 508, one or more human feedback configurations associated with the processing state are obtained including: a user to notify, a request communication channel corresponding to the user, an expected response type from the user, a response communication channel corresponding to the user, a timeout length prior to retry, and an unblock condition. For the human feedback special state, configurations of one or more of such users who are to be notified (send data to and from whom to request feedback) when the state is reached by a run at runtime are obtained. Configurations of one or more communication channels over which each such user is to notify is also obtained. For example, each user can be notified over each of one or more identified communication channels such as text messages, instant messages within a particular messaging application, email, or phone. Configurations of one or more communication channels over which each such notified user can send back a response are obtained. What the timeout length of waiting for a notified user's response should be before the request is resent to that user is also obtained. Which condition(s) must be met by the user's response before the run can un-pause and proceed to the next processing state in the graph are obtained. For example, one or more alternative unblock conditions can be configured for the human feedback special state such that one unblock condition, if met, could cause the run to proceed to a next processing state in the graph while another unblock condition, if met, could cause the run to return to a previous processing state in the graph. In some embodiments, the handoff primitive (e.g., the service associated with requesting feedback from one or more users) may be configured as a function, the parameters of which could be further configured in a process such as the example process as described in FIG. 6.

For example, it may be advantageous to include a human feedback special state in the worker program to bring in a person with subject matter expertise into the business workflow to verify the accuracy/quality of machine generated/synthesized data at runtime. For instance, upstream of the human feedback special state in the worker's graph, generative AI (e.g., an LLM) can be used to generate a first pass at a synthesis (e.g., summarization) of textual data (e.g., that may have been pulled from a data source and/or additionally processed). Then, the machine generated synthesis can be passed to the human feedback special state to cause the machine generated synthesis to be sent to at least one individual, who may be a subject matter expert and also someone different than the developer user that had composed the worker program (e.g., the worker program could have been configured by an engineer or data scientist but the person that is notified by the human feedback special state may have expertise in an area different from engineering or data science). In this specific example, the notified person may review the machine generated synthesis, make any edits, and then send the edited version of the machine generated synthesis as a response. Meanwhile, the run of the worker program pauses until the system receives a response that meets the unblock condition configured for the human feedback special state. Once the run resumes after the unblock condition is met, the human reviewed response is then passed to the next processing state of the worker program. The ability to add human feedback special states into the composition of the worker program allows the insertion of different personas in the beginning, middle, and/or end of a run of the workflow and allows the run to pause, resume, and dynamically change its path through the graph in way that is contingent on the human feedback received at each state. As mentioned above, the received human feedback during a run is also recorded in the run-specific audit log.

FIG. 6 is a flow diagram showing an example of a process for configuring function(s) within a processing state that have been added to a composition of a worker program in accordance with some embodiments. In some embodiments, process 600 may be implemented, at least in part, at worker program composition and invocation server 108 of FIG. 1. In some embodiments, step 306 of process 300 of FIG. 3 may be implemented, at least in part, using process 600. In some embodiments, steps 506 and/or 508 of process 500 of FIG. 5 may be implemented, at least in part, using process 600.

Process 600 describes an example process for configuring each function that is added to a processing state in a composition of a worker program at design time. An instance of process 600 can be implemented for each instance of a processing state for which functions can be added to the processing state in the composition of the worker program.

At 602, a user selection of a (next) new function to add to a current processing state in a composition of a worker program is received. In some embodiments, a function to add to a processing state represents a call (e.g., an API or protocol-based call) to an endpoint of a proprietary function (e.g., that is identified by its URL) or a call (e.g., an API or protocol-based call) to an endpoint of a function or model or service that is provided by a third-party service.

Examples of services/operations that are performed by a function may include data extraction, selection among multiple input data options, translation of data from one language into another, transcription of audio data into text data, sending a notification to a user and waiting to receive a response from that user, writing data to a specified data destination, prompting an LLM for a requested task (e.g., to summarize data), requesting and receiving feedback from a user (a “handoff primitive”) and fetching related documents from a storage location. For example, the function can be added to the processing state by selecting a preconfigured endpoint of a template function from a composition library or by providing an endpoint to a non-template function.

At 604, user configured parameters related to data flow into the new function are received. In some embodiments, parameters related to data flow into the new function include an input data source and an input data modality. The input data source parameter describes another node (e.g., a connector or a function of another processing state) within the graph of the composition of the worker program whose output data should be input into the new function in question. The input data modality describes the modality of data that originated from the input data source that is compatible with/required by/accepted by the function. The input data modality parameters may be identified as one or more of the following: a specified data type, a set of specified data fields, a specified file format, a specified encoding, a specified size of data, a specified language, and a specified data structure.

At 606, user configured other parameters related to the new function are received. Other parameters that could be configured for the new function include one or more of the following: a set of credentials that are needed to authenticate for accessing the endpoint associated with the function, a destination of the data that is to be output from the function, a modality of data that is to be output by the function, and one or more retry conditions. For example, the one or more retry conditions describe when and how to call the service associated with the function again in response to a previous determination that the service is unavailable/unresponsive or has returned a response that is determined to be invalid at runtime. In particular, the retry conditions can describe a waiting period after which the function will be called again, how the next call (e.g., prompt) to the function should be updated relative to a previous attempt, and/or when the function is determined to be unavailable such that a function in a fallback processing state in the graph should be called instead. With respect to the specific example of a function to call a generative AI service/LLM, the retry condition may describe that if the first prompt to the generative AI service/LLM does not return a desirable type of response, then a new prompt that is rephrased (e.g., to include more context of the requested task) should be generated and then sent to the service.

At 608, whether there is at least one more new function to add to the current processing state is determined. In the event that there is at least one more new function to add to the current processing state, control is returned to 602. Otherwise, in the event that there are no more new functions to add to the current processing state, process 600 ends. As mentioned above, depending on the type of the processing state, one or potentially more than one function can be added to that state.

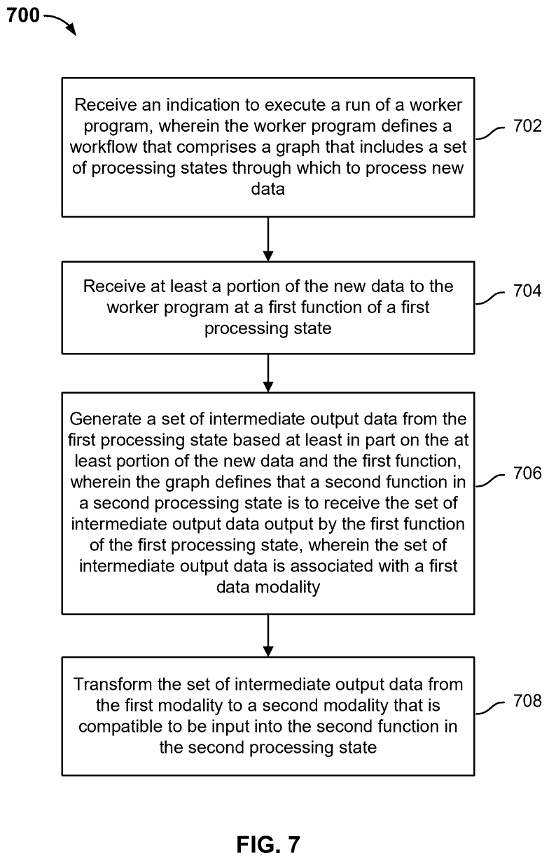

FIG. 7 is a flow diagram showing an embodiment of a process for executing a run of a worker program at runtime. In some embodiments, process 700 may be implemented, at least in part, at worker program composition and invocation server 108 of FIG. 1.

At 702, an indication to execute a run of a worker program is received, wherein the worker program defines a workflow that comprises a graph that includes a set of processing states through which to process new data. In some embodiments, at runtime, a run of the worker program that was previously composed and published using a processing such as process 300 of FIG. 3, for example, is invoked. For example, the run of the worker program is invoked in response to a call (which may include new data) to the endpoint of the worker program and/or new data being detected at a data source by a connector of the worker program.

At 704, at least a portion of the new data to the worker program is received at a first function of a first processing state. At least a portion of the new data that is ingested into the worker program by the invocation of the run is passed to a function in a first processing state of the graph. In some embodiments, if the new data is ingested by a connector, then the input schema associated with the connector is used to funnel and filter at least a portion of the new data to a function of a first processing state of the graph. In some embodiments, if the new data is ingested by a call to the endpoint of the worker program, then the new data is received at/passed to a function of a first processing state of the graph.

At 706, a set of intermediate output data is generated from the first processing state based on the at least portion of the new data and the first function, wherein the graph defines that a second function in a second processing state is to receive the set of intermediate output data output by the first function of the first processing state, wherein the set of intermediate output data is associated with a first data modality. The at least portion of the new data is processed by the first function of the first processing state. For example, the at least portion of the new data is processed by calling a proprietary or third-party service whose endpoint is associated with the first function of the first processing state. The data that is output by the first function of the first processing state is a set of intermediate output data that is to be passed to a second function in a second processing state of the graph according to the data flow parameters configured for the worker program.

At 708, the set of intermediate output data is transformed from the first modality to a second modality that is compatible to be input into the second function in the second processing state. Given that the set of intermediate output data that is output from the first function of the first processing state is associated with a first modality but that a second, different modality is required by the next, downstream node in the graph, the second function in the second processing state, the set of intermediate output data is transformed (in transit between these adjacent nodes) from the first modality to the second modality. Examples of transforming the set of intermediate output data include changing the file format of the data, changing the size of the data, filtering out a portion of the data, changing the encoding of the data, changing the structure of the data, and extracting out a portion of the data.

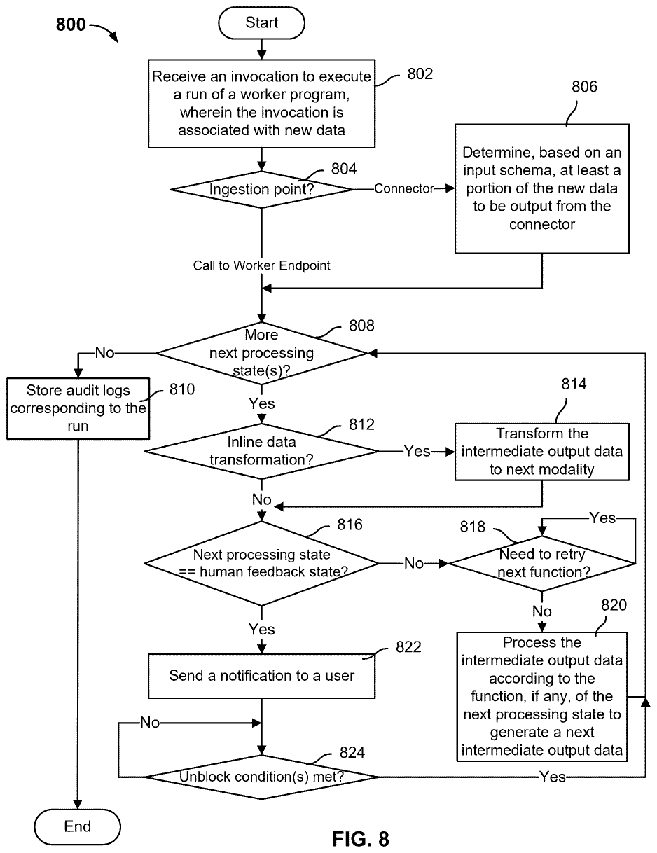

FIG. 8 is a flow diagram showing an example of a process for executing a run of a worker program at runtime in accordance with some embodiments. In some embodiments, process 800 may be implemented, at least in part, at worker program composition and invocation server 108 of FIG. 1. In some embodiments, process 700 of FIG. 7 may be implemented, at least in part, using process 800.

At 802, an invocation to execute a run of a worker program is received, wherein the invocation is associated with new data. In some embodiments, at runtime, a run of the worker program that was previously composed and published using a processing such as process 300 of FIG. 3, for example, is invoked. As mentioned above, a run of a worker program can be invoked and also new data can be ingested into the worker program in various ways. A first example type of invocation is when new data is detected from a specified data source by a connector of the worker program. A second example type of invocation is when a call (that includes new data) is made to the endpoint of the worker program. A third example type of invocation is when a call (that does not include new data) is made to the endpoint of the worker program and then the connector(s) of the worker program check respectively specified data sources for new data. In some embodiments, in addition to new data being ingested by the worker program in a run, runtime parameters (e.g., included in the call to the worker program) related to that run (e.g., that provides context of the call to the worker program) can also be ingested by the worker program.

At 804, an ingestion point of new data into the worker program is determined. In the event that the ingestion point for new data into the worker program is being detected by a connector of the worker program, control is transferred to 806. Otherwise, in the event that the ingestion point for new data into the worker program is from a call to the endpoint of the worker program, control is transferred to 808. In some embodiments, depending on how new data is ingested into the current run of the worker program, the new data may be treated differently at the point of ingestion. If the new data is ingested at a connector (e.g., based on the connector's detection of new data at the data source), then the new data is to be compared against the input schema that has been defined for that connector and at least a portion of the new data that matches the data fields that are expected by next a processing state (or function thereof) in the graph of the worker program is routed to that processing state. But if the new data is ingested into the worker program from a call (that includes the new data) made to the endpoint of the worker program, then the new data can be directly passed to the next processing state (or function thereof) in the graph.

At 806, based on an input schema of the connector, at least a portion of the new data is determined to be output from the connector to a next processing state.

At 808, whether there is at least one more next processing state in the run is determined. In the event that there is at least one more next processing state in the run, control is transferred to 812. Otherwise, in the event that there are no more (new) next processing states in the run, control is transferred to 810. Whether there is at least one more processing state to be visited in this run is determined. Put another way, whether the intermediate data that has been output from the previous node (e.g., a connector or a previous processing state) in the run should be input into another node (e.g., another processing state) is determined.

At 810, audit logs corresponding to the run are stored. As mentioned above, in various embodiments, for each run, an audit log of the path taken through the graph (e.g., the sequence of which connector(s) and processing states that were visited in the run) and an audit log of the runtime parameters and the data that was input to and output by each visited node in the graph are persisted (e.g., according to retention policies).

At 812, whether an inline data transformation is needed to be performed on the intermediate output data prior to inputting the intermediate output data to the next processing state is determined. In the event that the inline data transformation is needed to be performed, control is transferred to 814. Otherwise, in the event that inline data transformation is not needed to be performed, control is transferred to 816. Whether data transformation is needed to be performed on the data that was output from the previous node in the run to change the data from a first modality that is not compatible with the next processing state (or function thereof) to a second modality that is compatible with the next processing state (or function thereof) is determined.

At 814, the intermediate output data is transformed to a next modality. When this inline/in transit data transformation is needed, then the data that was output from the previous node in the run is transformed to match the shape/type of data that is required/accepted by the next processing state of the run.

At 816, whether the next processing state in the run is a human feedback state is determined. In the event that the next processing state in the run is a human feedback state, control is transferred to 822. Otherwise, in the event that the next processing state in the run is not a human feedback state, control is transferred to 818. Whether the next processing state to be visited in the run is a special state that requests human feedback is determined.

At 818, whether a next function in the next processing state is needed to be retried is determined. In the event that the next function in the next processing state is needed to be retried (e.g., because it is unavailable or non-responsive or otherwise responded with an invalid response), a retry technique is executed and the endpoint of the next function is called again. Otherwise, in the event that the next function in the next processing state is not needed to be retried, control is transferred to 820. In some embodiments, a function (if any) in the next processing state is called but the related service is unavailable/unresponsive/returns an invalid response. In that event, calling this function may be retried according to retry condition(s) that have been configured for that function. As shown in the example of process 800, this function may be called again after waiting a period (e.g., described by a retry condition) and/or called again with a different query. While not shown in process 800, a retry condition may prescribe for the run to visit a different, fallback processing state, which may include a function with an endpoint to a different service.

At 820, the intermediate output data is processed according to the function, if any, of the next processing state to generate a next intermediate output data. In the event that the next processing state includes at least a function, then the endpoint of the function is called using the intermediate output data (e.g., the data that was output from the previous node or a transformed version of that data). In some embodiments, calling the function includes generating a query or prompt that includes the data that is to be input into the current function. In some embodiments, generating the query or prompt includes populating a preconfigured template with values specific to the current run.

It is possible that the next processing state does not include a function such as a switch type function. In that case, in lieu of a function, the state may include a set of alternative conditions, each of which would map the intermediate output data to a different next processing state within the graph.

In the event that the next processing state is the last state in the graph, then the output from that processing state would also be the final output from the run. Depending on the function(s) that are included in the last state, the data output by the last state may be written to/stored at/presented at a destination location (e.g., file, user interface, cloud storage location) that has been configured for those function(s).

At 822, a notification is sent to a user. In the event that the next processing state is a special state that requests human feedback, then one or more users (e.g., reviewer personnel) that are identified by the configuration of the human feedback (“handoff”) state are notified according to the one or more request communication channels (e.g., phone, email, text message, or instant messaging) that have also been configured for that state. In a first example, the notification to the user(s) includes several enumerated options from which the user(s) can select. In a second example, the notification to the user(s) includes data (e.g., an AI generated text summary, a machine generated text translation) for the user(s) to approve of or edit.

At 824, whether unblock condition(s) of the human feedback state are met is determined. In the event that the unblock condition(s) of the human feedback state are not met, after a wait, control returns to 824. Otherwise, in the event that unblock condition(s) of the human feedback state are met, control is transferred to 808. In some embodiments, the run pauses after the notification is sent to the user(s) at the human feedback state until one or more responses are received from the user(s) over one or more of the response communication channels that meet the unblock condition(s) that have been configured for that state. In some embodiments, until a response that meet(s) the unblock condition(s) is met, the run remains paused (e.g., which could last for seconds, minutes, days, weeks, etc.). In a first example, an unblock condition can require the response to be a selection among one or more enumerated options. In a second example, an unblock condition can require the response to be one of an approval, a rejection, or an edited version of the data that was sent in the notification. In some embodiments, the unblock condition(s) can prescribe a different next processing state in the graph for the run to visit depending on the response that is received. For example, if the data that was sent in the notification was approved by a user, then the run may proceed to the next logical processing state in the graph but if the data that was sent in the notification was rejected by a user, then the run may revert to a logical previous processing state in the graph (e.g., to retry a previously called function thereof). In a specific example, if the user rejects an AI text summary at the human feedback state, then the run may return to a previous processing state that includes a function that had prompted the LLM to generate the summary to generate a new prompt for the LLM to generate a new summary, which will then be sent again to the user for review when the run again reaches the human feedback state.

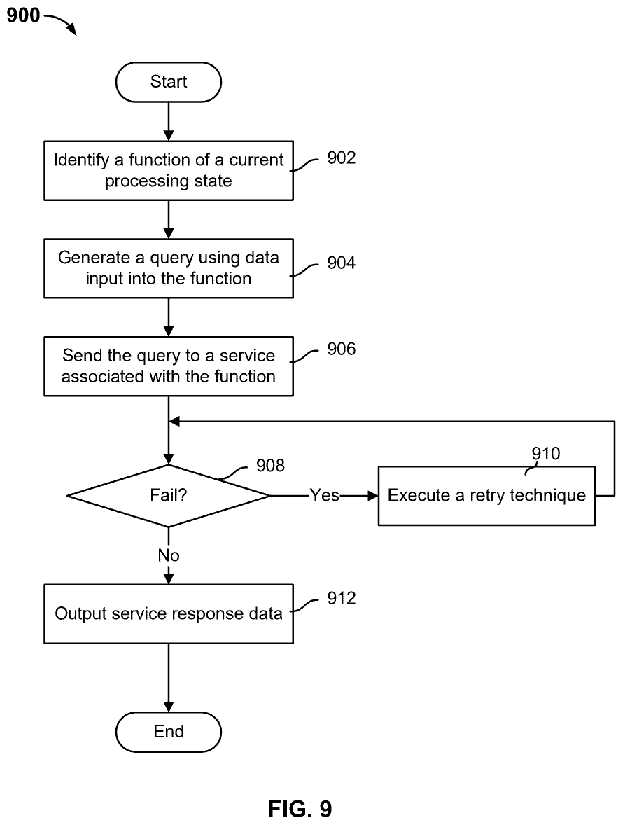

FIG. 9 is a flow diagram showing an example of a process for calling a function with a current processing state during a run of a worker program at runtime in accordance with some embodiments. In some embodiments, process 900 may be implemented, at least in part, at worker program composition and invocation server 108 of FIG. 1. In some embodiments, step 820 of process 800 of FIG. 8 may be implemented, at least in part, using process 900.

Process 900 is an example process that describes how each function of a processing state in the graph of a worker program that is currently being run can be called.

At 902, a function of a current processing state is identified. A function that is associated with the processing state that a run of a worker program is currently visiting is determined. For example, the function can be identified by a corresponding service endpoint and/or name. The endpoint can be associated with a third-party service or a proprietary service (e.g., proprietary to the organization that had composed the worker program at design time). Examples of a service associated with a function include data extraction, selection among multiple input data options, translation of data from one language into another, transcription of audio data into text data, sending a notification to a user and waiting to receive a response from that user, writing data to a specified data destination, prompting an LLM for a requested task (e.g., to summarize data), and fetching related documents from a storage location.

At 904, a query is generated using data input into the function. In some embodiments, data that is to be input into the function is passed from a previous node (e.g., a connector, another processing state (or function thereof)) in the graph. In some embodiments, a query to use to call the service to process the input data can be generated depending on the service that is associated with the function. In a first example, if the service were an LLM or other generative AI model, then a prompt could be generated by inserting the input data into a prompt template for querying the LLM to perform a requested task. In a second example, if the service responds to a specific API/protocol (e.g., REST, gRPC), then a command/request that is associated with that API/protocol can be dynamically generated to include the input data and any relevant runtime parameters associated with the run.

At 906, the query is sent to a service associated with the function. Sending the query to a service includes sending the query to the endpoint associated with the function.

At 908, whether the query to the function has failed is determined. In the event that the query to the function has failed, control is transferred to 910. Otherwise, in the event that the query to the function has not failed, control is transferred to 912. The query may be determined to have failed if, for example, the queried service is unavailable, nonresponsive, returns a response that is determined to be undesirable or in an unexpected/invalid format, etc. For example, at the time of the query being sent, the service may be experiencing an outage.

At 910, a retry technique is executed. The technique to use to retry the query to the function may depend on the type of failure that was determined at step 908. For example, if the type of failure was determined to be an unavailable or nonresponsive service, then the query can be resent to the function's endpoint after waiting a predetermined length of time. In another example, if the type of failure was determined to be a returned response that is undesirable or in an unexpected/invalid format, then the query can be updated before being resent to the function's endpoint. For example, if the service were an LLM or other generative AI model, then the prompt can be updated before being resent to the service. Specifically, the language included in the prompt can be modified by the use of a different prompt template or by including more or less context into the prompt prior to sending the updated prompt to the service.

At 912, service response data is outputted. After the function is successfully queried and processed data is received from the service, the response data can be written to the context/data plane of the run and also output as intermediate output data to the next processing state in the run.

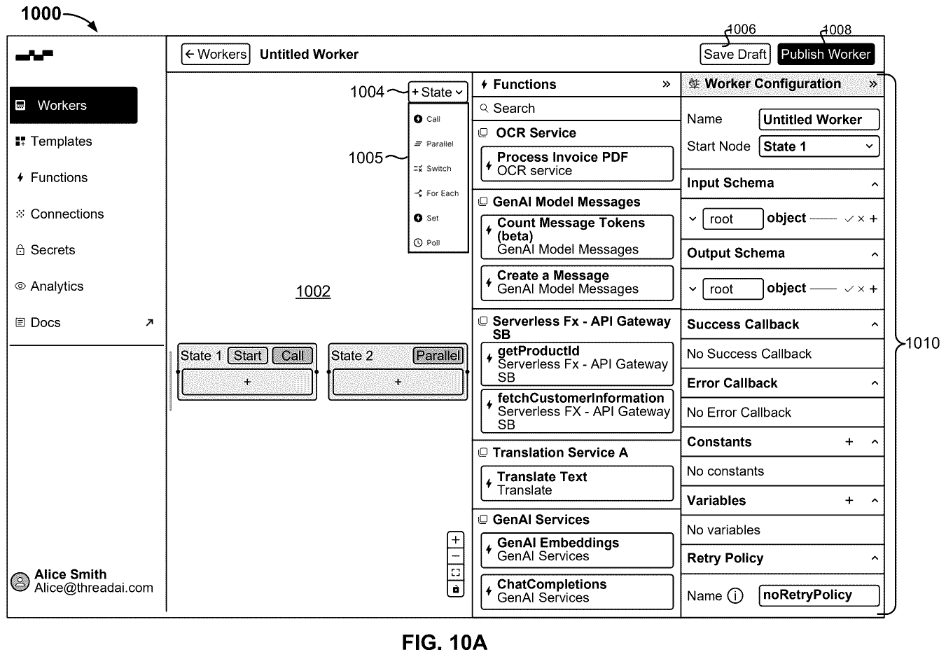

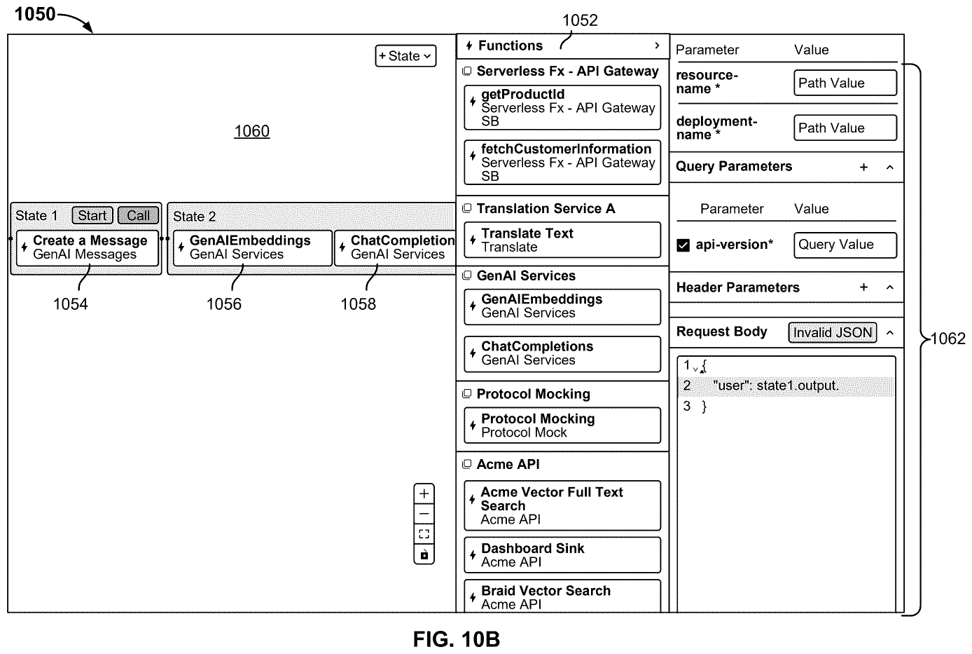

FIG. 10A is a diagram showing an example of a user interface-based tool for composing a worker program at design time in accordance with some embodiments. In some embodiments, user interface 1000 is provided by worker program composition and invocation server 108 of FIG. 1. As shown in the example of FIG. 10A, user interface 1000 includes input area 1002 in which visual representations of elements (e.g., connector(s), processing state(s), and function(s)) with which to compose a worker program can be added. In particular, to add a new processing state, the user can select “State” button 1004 to prompt drop down menu 1005 of different processing state types (e.g., call, parallel, switch, for each, set, poll) to appear. In response to a user selection of a presented processing state type, a corresponding visual representation of one instance of that type of processing state will appear in input area 1002. In the example of user interface 1000, the user had already selected to add processing state “State 1” and processing state “State 2” to the composition of the current worker program in input area 1002. Processing state “State 1” is a “call” type of state, which is configured to call a single function (which is to be added by the user to the representation of “State 1” in user interface 1000). Processing state “State 2” is a “parallel” type of state, which is configured to call two or more functions (each of which is to be added by the user to the representation of “State 2” in user interface 1000) in parallel. The user can configure other worker-level parameters at panel 1010.

If the user wants to save the current progress of the composition of the worker program, then the user can select “Save Draft” 1006 button to save the draft, which can be opened later for editing. When the user later completes the composition of the worker program, then the user can select “Publish Worker” 1008 to trigger a validation process and if the composition passes validation, then an endpoint for the completed/validated worker program is dynamically generated, as will be described below.

FIG. 10B is a diagram showing another example of a user interface-based tool for composing a worker program at design time in accordance with some embodiments. In some embodiments, user interface 1050 is provided by worker program composition and invocation server 108 of FIG. 1. User interface 1050 shows that one or more functions have been selected by the user to add to each of processing state “State 1” and processing state “State 2” in the composition of the current worker program in input area 1060. Specifically, after the user had added each of processing state “State 1” and processing state “State 2” to the composition of the current worker program as shown in user interface 1000 of FIG. 10A, the user selected one function, function 1054, from function menu 1052 to add to processing state “State 1” and selected two functions, functions 1056 and 1058, to add to processing state “State 2.” The user can configure other function-level parameters at panel 1062.

While not shown in FIG. 10B, the user can eventually add wiring to connect together the configured processing states (e.g., including processing state “State 1” and processing state “State 2”) within input area 1060 to complete the graph of the worker program that is being composed/edited.

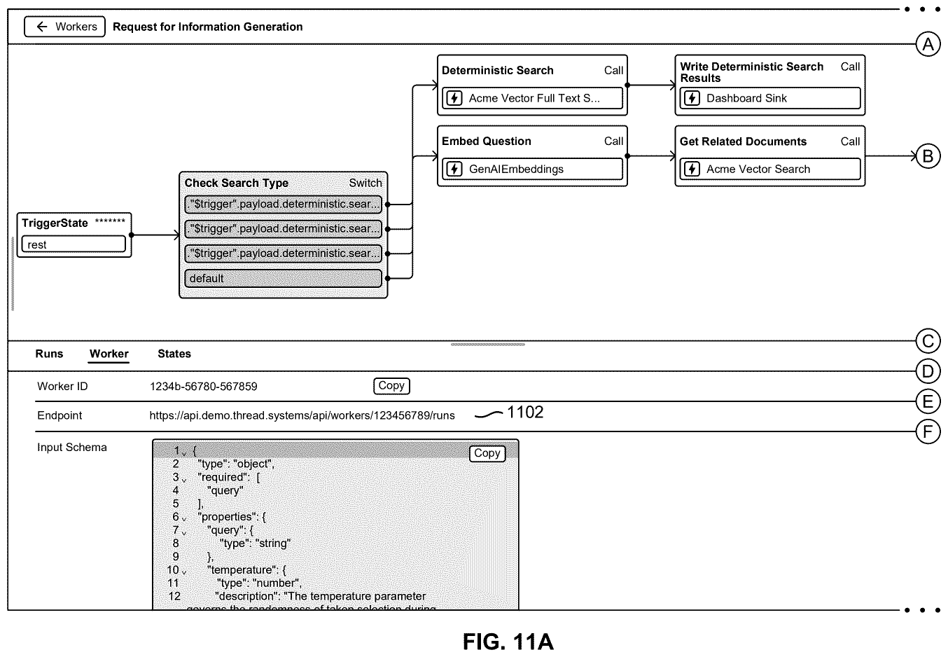

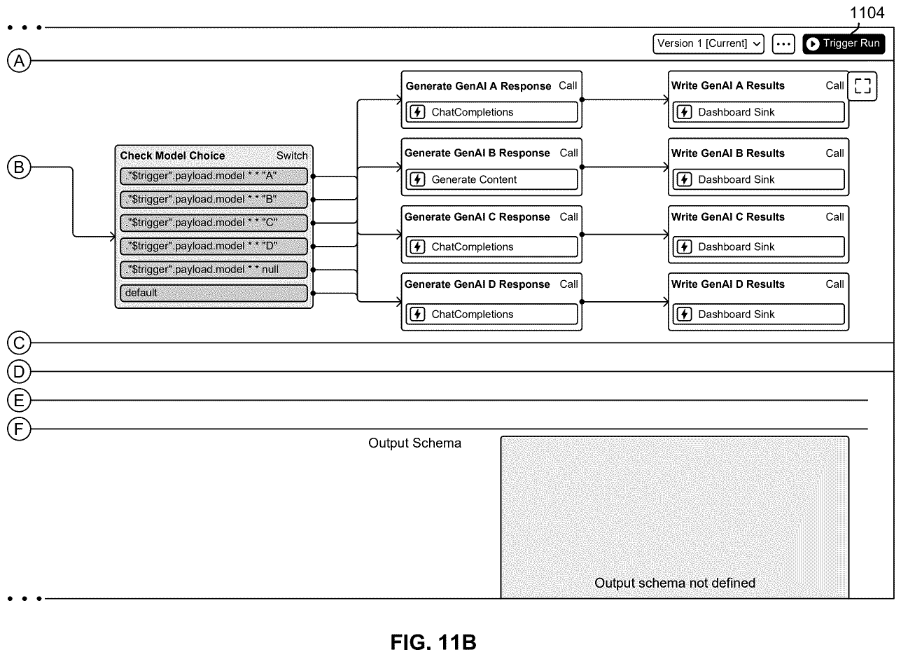

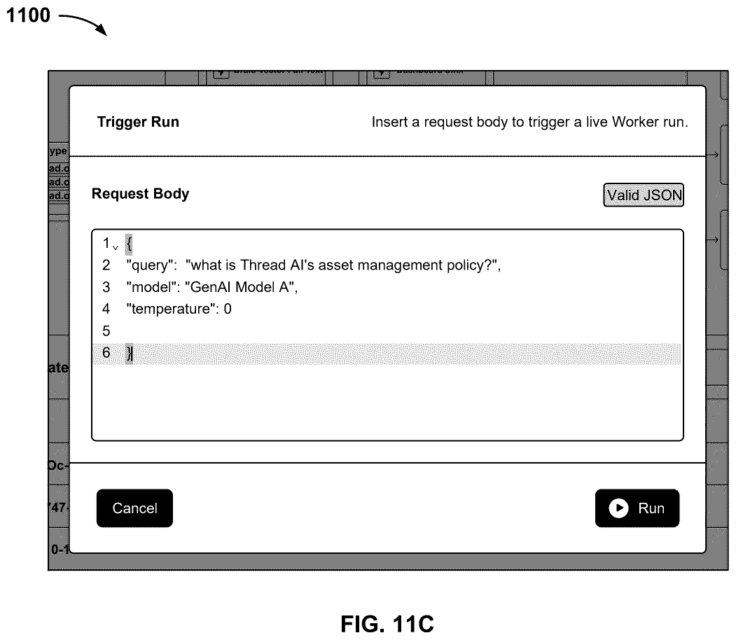

FIGS. 11A and 11B show an example of a user interface for presenting a generated endpoint of a published worker program at design time in accordance with some embodiments. In particular, FIG. 11A comprises the left half of a user interface that shows the left half of a graph of configured elements of the worker program and FIG. 11B comprises the right half of the user interface that shows the right half of the graph. After the user had completed the composition of the graph, the user had selected to publish the worker program.

Then, after the graph had been validated, endpoint 1102 corresponding to the validated worker program is presented at the user interface. Endpoint 1102 can then be incorporated into an operational context (e.g., a website or an application) so that one or more runs of the worker program can be invoked using endpoint 1102.

FIG. 11C shows an example of a window that is presented in response to trigger a run of a published worker program at design time in accordance with some embodiments. For example, in response to a user selection of “Trigger Run” button 1104 of FIG. 11B, window 1100 is presented in which the user can trigger the worker program by providing new data to be ingested by the worker program. Enabling manual triggering of a published worker program could be a helpful way to test the workflow that is implemented by the worker program and evaluate whether the recorded audit logs of the test run conform to expected results (e.g., prior to making the worker program available in an operational context).

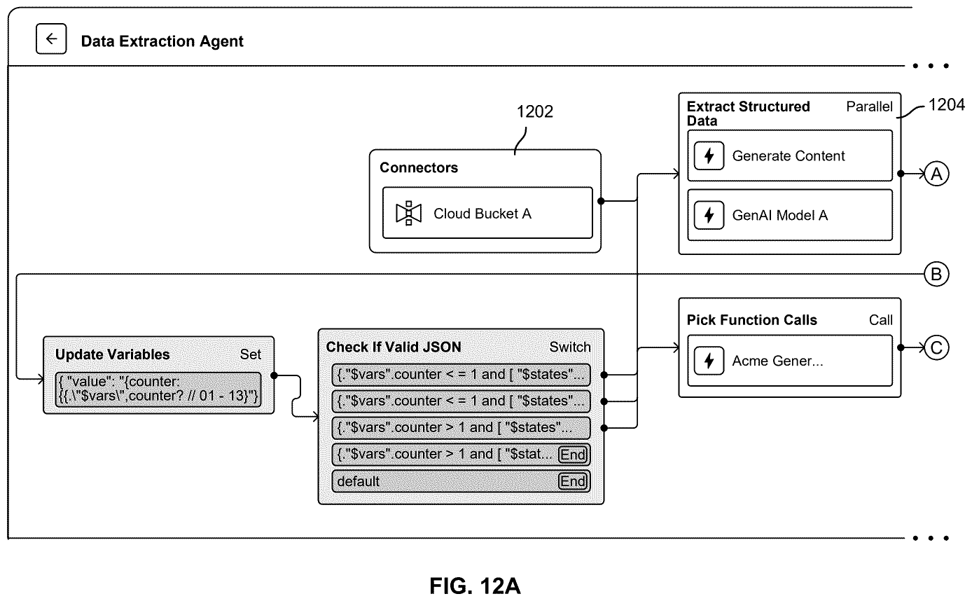

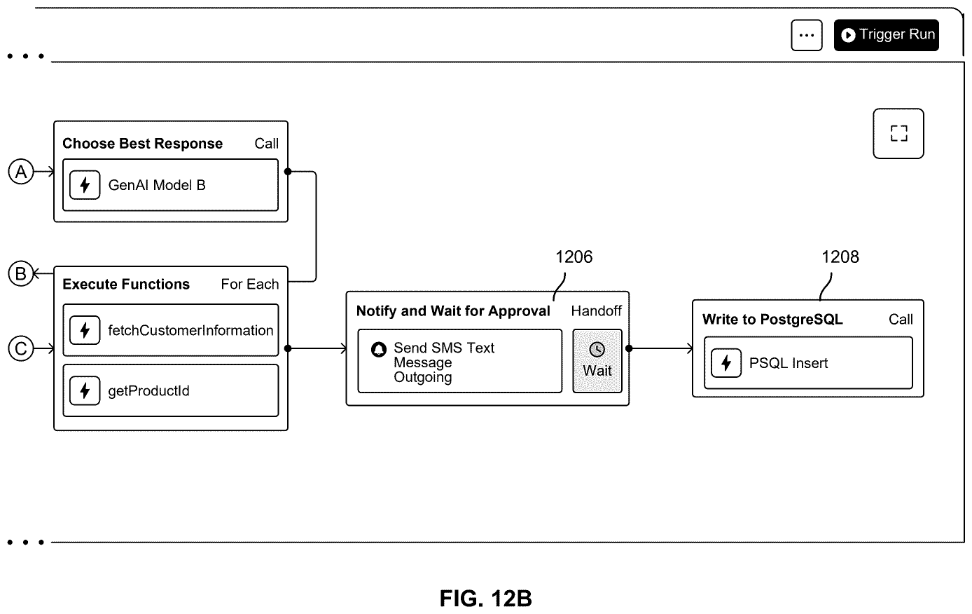

FIGS. 12A and 12B show the graph of an example of a published worker program configured to implement a workflow of a data extraction agent in accordance with some embodiments. In particular, FIG. 12A comprises the left half of a user interface that shows the left half of the graph and FIG. 12B comprises the right half of the user interface that shows the right half of the graph. In general, during an invoked run at runtime, the workflow that is represented by the example worker program across FIGS. 12A and 12B ingests data from a specified data source, extracts specified data fields from at least a portion of the ingested data, fetches additional information for the extracted data, hands off the fetched data for the extracted data to a user review, and upon user approval of the information, writes the user approved information to a destination database. Specifically, the workflow that is represented by the example worker program ingests new data from a specified cloud storage bucket at connector 1202 to invoke a new run of the worker program. Then, at least a portion of the ingested new data is passed, according to the input schema of connector 1202, to “parallel” processing state 1204, which calls each of two configured functions related to structured data extraction on the received data. The intermediate output data that is output from parallel processing state 1204 is input into and processed by each next processing state (e.g., using a process such as process 800 of FIG. 8) until eventually, a human feedback special state, “handoff” processing state 1206, is reached. The structured text data (generated from the previous nodes in the run) that is input into handoff processing state 1206 is sent in a notification message to one or more users via short message service (SMS) text message(s). The run of the worker program will pause until a response that meets the unblock conditions of “handoff” processing state 1206 is received, after which the run will proceed to the last processing state of the graph, “call” processing state 1208. The user approved data that is output from “handoff” processing state 1206 is input into “call” processing state 1108, which is configured to call a function that writes the data to a specified destination (a PostgreSQL database). As shown in the example worker program of FIGS. 12A and 12B, the addition of a “handoff” processing state can selectively insert a human in the loop review into an otherwise programmatically executed workflow to ensure that the data that is to be committed to a destination location meets a desired standard. A human in the loop review may be particularly helpful where generative AI has been applied upstream to the data, to curb and minimize the impact of potential hallucinations by the AI.

While not described with the example of FIGS. 12A and 12B, during a run, data transformation could occur at one or more of the processing states as well as in transit from one processing state to another.

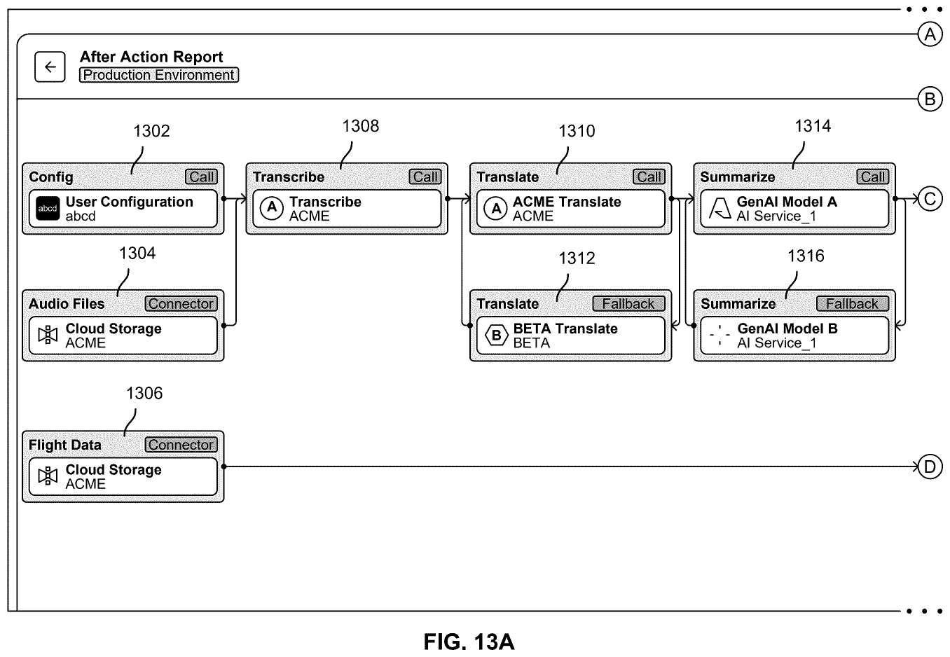

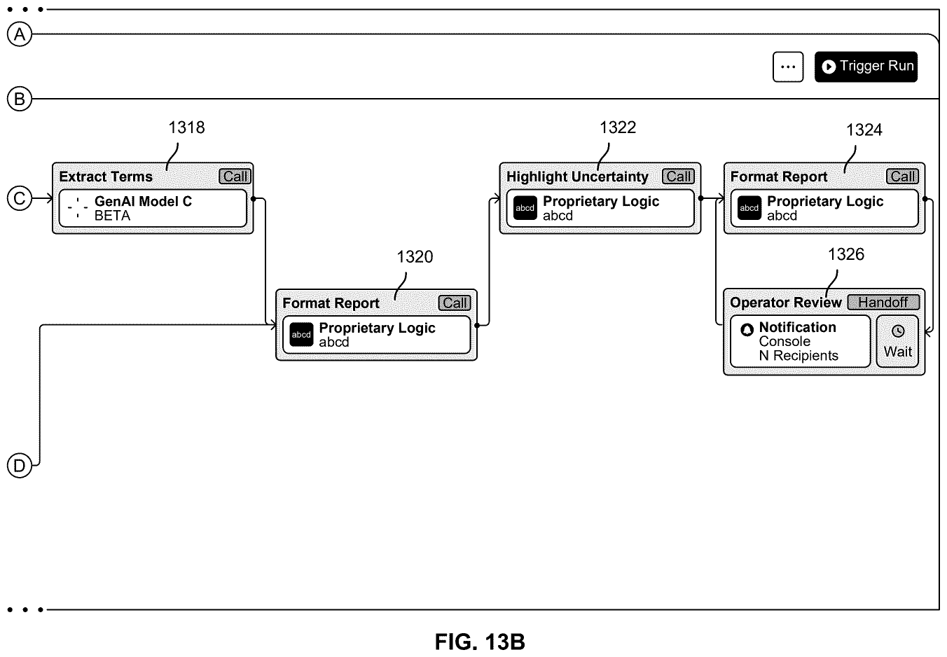

FIGS. 13A and 13B show the graph of an example of a published worker program configured to implement a workflow of an after action report generating agent in accordance with some embodiments. In particular, FIG. 13A comprises the left half of a user interface that shows the left half of the graph and FIG. 13B comprises the right half of the user interface that shows the right half of the graph. In general, during an invoked run at runtime, the workflow that is represented by the example worker program across FIGS. 13A and 13B receives a call/trigger to check for new audio and flight data, pulls new audio and flight data from respective data sources in response to the call/trigger, calls a transcription service to transcribe the pulled audio data into text, calls a translation service to translate the input text into a target language, calls a generative AI service to summarize the translated text, extracts terms from the text summary, calls a proprietary service to format an after action report that includes the extracted terms and the flight data, calls a proprietary service to highlight uncertain components of the formatted report, calls another proprietary service to reformat the report with the highlighted uncertainties, and then hands off the formatted report to a user for review.

One example application of the workflow represented across FIGS. 13A and 13B is to generate after action reports based on data captured by drones deployed to document incidents after they occur. Such an example workflow can be configured by or for safety agencies to efficiently and accurately document incidents after they occur. After action reports (AARs) are important for analyzing past performances and enhancing future actions. However, manually creating AARs can be a time-consuming and tedious process, often relying on manual data entry from first responders who are already stretched thin. These reports contain a detailed review of a specific incident or operation, such as a crime scene investigation, arrest, or tactical response. Its primary goal is to identify areas for improvement, learn from mistakes, and enhance future performance. It involves the review of written assets and hours of audio and sometimes video assets. While reviews are often used for internal purposes, there are cases when they may be required for submission as supplemental evidence in court. As will be described in further detail below, the workflow represented across FIGS. 13A and 13B both improves and automates some of the manual processing involved in AAR generation in a way that is secure, observable, durable, and allowed for various experimentation techniques with clear human in the loop access points.

Specifically, a run of the example worker program whose graph is depicted across FIGS. 13A and 13B is triggered in response to a (e.g., REST) call to “call” processing state 1302, or in response to new audio files being pulled from a specified cloud storage bucket at connector 1304 and/or new flight data (e.g., in JSON format) being pulled from a specified cloud storage bucket at connector 1306, or a combination of both. The call to “call” processing state 1302 may optionally include runtime parameters such as, for example, the geographic location of a documented incident, a specific language being spoken, and background noise levels, and such parameters may inform the execution of downstream processing states in the run, as will be described below. Examples of the audio files fetched at connector 1304 may include MP3, MP4, FLAC, and WAV. The audio files that are fetched by connector 1304 may be compared against an input schema configured for that connector to determine the at least portion of the audio files to be passed to the downstream node (e.g., “call” processing state 1308). The flight data that is fetched by connector 1306 may be compared against an input schema configured for that connector to determine the at least portion to be passed to the downstream node (e.g., “call” processing state 1320). An inline data transformation may be performed on the audio files that are passed from connector 1304 and “call” processing state 1308 to ensure that the audio data to input into “call” processing state 1308 is compatible with the function to call a transcription service therein. Examples of data transformations that can be performed between connector 1304 and “call” processing state 1308 may include changing the audio encoding of the audio files and/or trimming the length of the audio files. The transformed audio files that are input into “call” processing state 1308 may be included, along with any other runtime parameters (e.g., background noise level, specific language being spoken), in a dynamically generated (e.g., API/protocol appropriate) query to the transcription service that is to be called by the function of “call” processing state 1308. The text transcription of the audio files is then output by “call” processing state 1308 and into “call” processing state 1310, which is configured to translate the input text into a specified target language. An inline data transformation may be performed on the text transcription that is passed from “call” processing state 1308 to “call” processing state 1310 to ensure that the text data to input into “call” processing state 1310 is compatible with the function to call a translation service therein. Examples of data transformations that can be performed between “call” processing state 1308 to “call” processing state 1310 may include changing the structured text transcription into a string (e.g., by concatenating the words of the structured text), breaking out text spoken by different speakers into respective strings, and/or filtering out transcribed words that were assigned a low confidence by the transcription service. The transformed text transcriptions that are input into “call” processing state 1310 may be included, along with any other runtime parameters (e.g., specific language being spoken), and a specified target language in a dynamically generated (e.g., API/protocol appropriate) query to the translation service that is to be called by the function of “call” processing state 1310. In the event that the function configured to call the translation service of “call” processing state 1310 fails (e.g., the service is unavailable even after retry attempts are made), the transformed text transcriptions are then instead input into “call” processing state 1312, which is configured to call a fallback translation service therein using an API/protocol appropriate query for the fallback service. The text translation that is successfully returned/output by whichever one of “call” processing state 1310 and “call” processing state 1312 is then input into “call” processing state 1314, which is configured to summarize the input translated text into a human-readable summary of the text. The translated text that is input into “call” processing state 1314 may be included, along with any other runtime parameters (e.g., geographic location, specific language originally spoken in) into a dynamically generated prompt to the generative AI model (e.g., LLM) that is to be called by the function of “call” processing state 1314. For example, the prompt can be generated by populating a prompt template with the input text and runtime parameters. In the event that the function configured to call the generative AI model of “call” processing state 1314 fails (e.g., the service is unavailable even after retry attempts are made), the translated text is then instead input into “call” processing state 1316, which is configured to call a fallback generative AI model therein using a dynamically generated prompt appropriate for the fallback service. The text summary that is successfully returned/output by whichever one of “call” processing state 1314 and “call” processing state 1316 is then input into “call” processing state 1318, which is configured to extract terms from the human-readable text summary. The text summary that is input into “call” processing state 1318 may be included with a specification of terms to extract in a dynamically generated (e.g., API/protocol appropriate) query the generative AI model (e.g., LLM) that is to be called by the function of “call” processing state 1318. The extracted terms that are returned by “call” processing state 1318 are then input into “call” processing state 1320 along with the flight data from connector 1304. “Call” processing state 1320 is configured to format the input extracted terms and flight data into a human readable after the action report. The extracted terms and flight data that are input into “call” processing state 1320 may be included in a dynamically generated (e.g., API/protocol appropriate) query to the proprietary report generation service that is to be called by the function of “call” processing state 1320. The formatted after action report that is returned by “call” processing state 1320 is then input into “call” processing state 1322, which is configured to highlight uncertain aspects/components within the input after action report. The formatted after action report that is input into “call” processing state 1322 may be included in a dynamically generated (e.g., API/protocol appropriate) query to the proprietary uncertainty highlighting service that is to be called by the function of “call” processing state 1322. The formatted after action report with highlighted uncertainties that is returned by “call” processing state 1322 is then input into “call” processing state 1324, which is configured to update the input after action report based on the highlighted uncertainties. The formatted after action report with highlighted uncertainties that is input into “call” processing state 1324 may be included in a dynamically generated (e.g., API/protocol appropriate) query to the proprietary report generation service that is to be called by the function of “call” processing state 1324. Finally, the updated formatted after action report that is returned by “call” processing state 1324 is then input into “handoff” processing state 1326, which is configured to send a notification with the updated formatted after action report to a user (e.g., for review/approval). The updated formatted after action report that is input into “handoff” processing state 1326 may be included in a notification/presentation that is output/published to one or more users over one or more request communication channels.

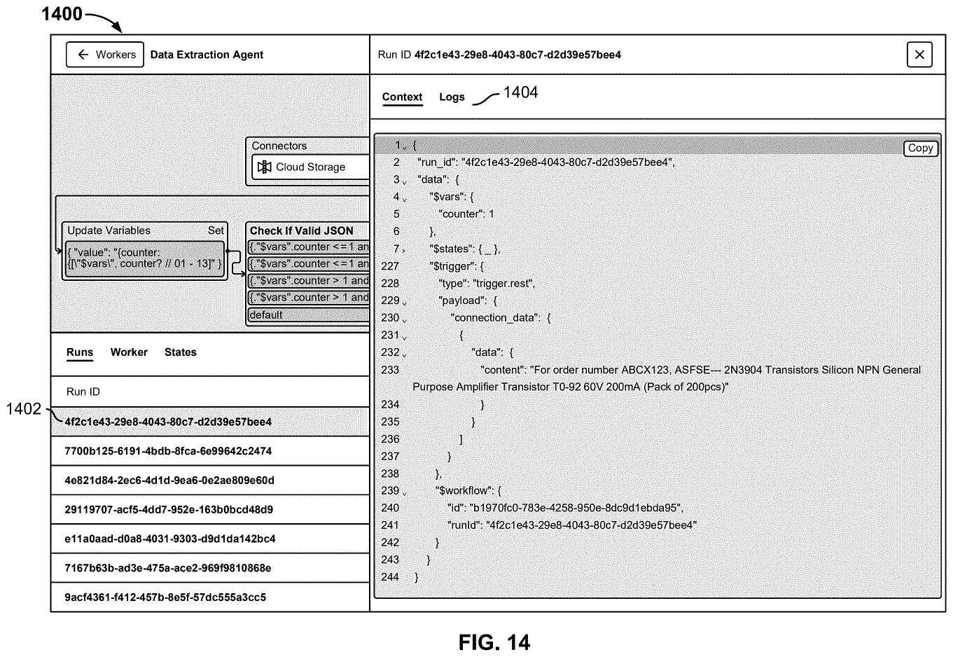

FIG. 14 is a diagram that shows an example of a user interface for presenting run-specific audit data in accordance with some embodiments. As shown in FIG. 14, during the execution of each run of the example published worker program (“Data Extraction Agent”) at runtime, the node-by-node path through the graph of the worker program that is visited by the run is recorded as audit logs. Furthermore, the data that is inputted and outputted from each visited node as well as the runtime parameters are also stored as context for that run. In the example of FIG. 14, user interface 1400 shows the IDs of multiple historical runs of the worker program. In response to a user selection of run 1402, window 1404 is presented to show the stored audit information for that selected run. In particular, window 1404 allows the user to select either the “Context” tab to view the stored context/data plane of the run or “Logs” tab to view the stored path of the run. Such run-specific audit information is invaluable for manual observation/oversight and any troubleshooting of the worker program to ensure that the implemented workflow is generating expected/desirable results at each node of an executed run.

Various embodiments described herein enable the composition of worker programs at design time by allowing the chaining together of arbitrary processing states that can include calls to either proprietary and/or third-party services. When invoked at runtime, a composed worker program will then programmatically implement a corresponding workflow that may include the linear or non-linear execution of the configured processing states. Additionally, during a run of a worker program, calls in the applicable API/protocol are generated for the function of each visited processing state and data transformation is also performed, when needed, on data in between adjacent processing states to accommodate the different modalities that may be required by different services/models. Furthermore, while the workflow of a worker program can be executed entirely programmatically, human feedback (e.g., review, approval, or selection) can be inserted at any point in the workflow to strategically leverage personnel expertise (e.g., to act as a guardrail on AI-generated output).

Although the foregoing embodiments have been described in some detail for purposes of clarity of understanding, the invention is not limited to the details provided. There are many alternative ways of implementing the invention. The disclosed embodiments are illustrative and not restrictive.

1. A system, comprising:
a storage device configured to store a worker program, wherein the worker program defines a workflow that comprises a graph that includes a set of processing states through which to process new data; and
one or more processors configured to execute a run of the worker program including to:
determine that a trigger associated with a connector of the worker program has been met for checking for the new data;
obtain the new data from a data source as defined by the connector of the worker program;
compare the new data against an input schema associated with the connector of the worker program to determine at least a portion of the new data to map to a first function of a first processing state, wherein the at least portion of the new data comprises one or more data fields of the new data;
receive the at least a portion of the new data at the first function of the first processing state;
generate a set of intermediate output data from the first processing state based on the at least portion of the new data and the first function, wherein the graph defines that a second function in a second processing state is to receive the set of intermediate output data output by the first function of the first processing state, wherein the set of intermediate output data is associated with a first data modality;
store, in an audit log comprising a context associated with the run of the worker program, that the set of intermediate output data associated with the first data modality is output from the first function of the first processing state;
transform the set of intermediate output data from the first data modality to a second data modality that is compatible to be input into the second function of the second processing state; and
store, in the audit log comprising the context associated with the run of the worker program, that the transformed set intermediate output data associated with the second data modality is input into the second function of the second processing state.

2. The system of claim 1, wherein the one or more processors are further configured to:
receive user configuration(s) of a set of connectors to add to a composition of the worker program;
receive user configuration(s) of the set of processing states to add to the composition;
receive user configuration(s) of respective zero or more functions to add to each processing state of the set of processing states; and
receive user configuration(s) of logical wiring among the set of connectors and the set of processing states.

3. The system of claim 2, wherein the user configuration(s) of the set of connectors comprise one or more of the following: the data source corresponding to the connector, authentication information corresponding to the data source, the new data checking trigger associated with the connector, and the input schema corresponding to the connector.

4. The system of claim 2, wherein the user configuration(s) of the set of processing states comprise one or more of the following related to a handoff type of processing state: a user to notify, a request communication channel, an expected response type, a response communication channel, a timeout length prior to retry, and an unblock condition.

5. The system of claim 2, wherein the user configuration(s) of the respective zero or more functions to add to each processing state comprise one or more of the following related to a function: an endpoint of the function, an input data source, an input data modality, an output data modality, an output data destination, and a retry condition.

6. The system of claim 2, wherein the one or more processors are further configured to:
infer a needed in transit data transformation between a pair of adjacent nodes of the graph; and
add a definition corresponding to the in transit data transformation between the pair of adjacent nodes of the graph to the composition.

7. The system of claim 2, wherein the one or more processors are further configured to:
receive a request to publish the worker program;
perform one or more validation checks on the composition of the worker program;
convert the composition of the worker program into a domain-specific language (DSL); and
dynamically generate an endpoint corresponding to the worker program.

8. (canceled)

9. The system of claim 1, wherein prior to receiving the at least portion of the new data at the first function of the first processing state, the one or more processors are further configured to receive additional new data from a call to an endpoint corresponding to the worker program.

10. The system of claim 1, wherein to generate the set of intermediate output data from the first processing state based on the at least portion of the new data and the first function comprises to:
generate a query associated with the first function including the at least portion of the new data; and
send the query to an endpoint associated with a service associated with the first function.

11. The system of claim 10, wherein the query is generated using an application programming interface (API) or protocol that is associated with the first function.

12. The system of claim 1, wherein the one or more processors are further configured to:
determine that a call to the second function of the second processing state has failed; and
perform a retry attempt to call the second function based on a retry condition associated with the second function.

13. The system of claim 1, wherein the one or more processors are further configured to:
determine that the second processing state comprises a handoff state; and
send a notification to a user to request a response over a request communication channel, wherein the notification comprises the transformed set of intermediate output data.

14. The system of claim 13, wherein the one or more processors are further configured to:
pause the run of the worker program;
receive the response from the user over a response communication channel; and
in response to a determination that the response meets an unblock condition associated with the second processing state, resume the run of the worker program.

15. The system of claim 1, wherein the audit log comprises a first audit log, and wherein the one or more processors are further configured to:
store a second audit log related to a logical path taken through the graph by the run.

16. A method, comprising:
receiving an indication to execute a run of a worker program, wherein the worker program defines a workflow that comprises a graph that includes a set of processing states through which to process new data;
determining that a trigger associated with a connector of the worker program has been met for checking for the new data;
obtaining the new data from a data source as defined by the connector of the worker program;
comparing the new data against an input schema associated with the connector of the worker program to determine at least a portion of the new data to map to a first function of a first processing state, wherein the at least portion of the new data comprises one or more data fields of the new data;
receiving the at least a portion of the new data at the first function of the first processing state;
generating a set of intermediate output data from the first processing state based on the at least portion of the new data and the first function, wherein the graph defines that a second function in a second processing state is to receive the set of intermediate output data output by the first function of the first processing state, wherein the set of intermediate output data is associated with a first data modality;
storing, in an audit log comprising a context associated with the run of the worker program, that the set of intermediate output data associated with the first data modality is output from the first function of the first processing state;
transforming the set of intermediate output data from the first data modality to a second data modality that is compatible to be input into the second function of the second processing state; and
storing, in the audit log comprising the context associated with the run of the worker program, that the transformed set intermediate output data associated with the second data modality is input into the second function of the second processing state.

17. The method of claim 16, further comprising:
receiving user configuration(s) of a set of connectors to add to a composition of the worker program;
receiving user configuration(s) of the set of processing states to add to the composition;
receiving user configuration(s) of respective zero or more functions to add to each processing state of the set of processing states; and
receiving user configuration(s) of logical wiring among the set of connectors and the set of processing states.

18. The method of claim 17, wherein the user configuration(s) of the set of connectors comprise one or more of the following: the data source corresponding to the connector, authentication information corresponding to the data source, the new data checking trigger associated with the connector, and the input schema corresponding to the connector.

19. The method of claim 17, wherein the user configuration(s) of the set of processing states comprise one or more of the following related to a handoff type of processing state: a user to notify, a request communication channel, an expected response type, a response communication channel, a timeout length prior to retry, and an unblock condition.

20. The method of claim 17, wherein the user configuration(s) of the respective zero or more functions to add to each processing state comprise one or more of the following related to a function: an endpoint of the function, an input data source, an input data modality, an output data modality, an output data destination, and a retry condition.
